(19) United States
(12) Patent Application Publication
(10) Pub. No.: US 2024/0100617 A1
(43) Pub. Date: Mar. 28, 2024

(54) HYBRID POWER WELDING SYSTEM

(71) Applicant: ESAB AB, Goteborg (SE)

(72) Inventors: Mark Lowther, Warrington (GB); Govarthanan Rengamuni, Chennai (IN); Paramasivam Shanmugam, Chennai (IN)

(21) Appl. No.: 18/534,025

(22) Filed: Dec. 8, 2023

Related U.S. Application Data
(63) Continuation of application No. PCT/IB2022/055354, filed on Jun. 8, 2022.

(30) Foreign Application Priority Data
Jun. 8, 2021 (IN) 202141025457

(51) Int. Cl. B23K 9/10; B23K 28/02

(52) U.S. Cl. CPC B23K 9/1075; B23K 9/1043; B23K 28/02

(57) ABSTRACT

A hybrid welding power system includes: an AC/DC converter (101) to generate a rectified voltage from AC input power; a boost circuit (102) to generate a DC link voltage from the rectified voltage; an inverter (104) to generate a transformer input from the DC link voltage in accordance with a welding operation; an HF transformer (106) to receive the transformer input and generate a transformer output; a secondary rectifier (108) to rectify the transformer output to generate output welding power to be supplied to a weld output of the welding power system; and a battery power converter to couple a battery (112) to the DC link, the transformer (106), or the weld output to enable discharging of the battery (112) to the hybrid welding power system and enables charging of the battery (112) via the AC input, the DC link, the transformer (106), or the weld output in various implementations.

### CROSS REFERENCE TO RELATED APPLICATIONS

This application is a continuation of International (PCT) Patent Application No. PCT/IB2022/055354, filed Jun. 8, 2022, and entitled “Hybrid Power Welding System,” which claims priority to and is based on Indian Application No. 202141025457, filed Jun. 8, 2021, and entitled “Hybrid Power Welding System.” The entire disclosure of each of these applications is incorporated herein by reference.

### TECHNICAL FIELD

The subject disclosure relates to a hybrid power welding system having a welding power source operable in several power modes, including a battery-powered welding mode, a battery charging mode, an AC-powered welding mode, and combinations thereof.

### BACKGROUND

Welding power sources typically generate output welding power for welding or cutting processes by converting alternating current (AC) input power to a direct-current (DC) voltage, and then converting the DC voltage to output power suitable for the welding or cutting process via a weld process regulator. The AC input power may be supplied from AC mains or, in remote settings where power from AC mains may not be available, a generator may be required to supply AC input power.

The available AC input power may be insufficient for welding operations in some circumstances. Certain welding modes of operation may require more power than can be sustainably derived from power levels supplied by locally available AC mains. Further, input voltage dips, called “sags,” can disrupt welding operations. Specifically, the welding power source may regulate the output welding power by adjusting the duty cycle of inverters in the weld process regulator and/or by generating the DC power using a boost power factor correction (PFC) circuit or the like, which attempts to supply a constant “DC link” voltage to the weld process generator even in the case of input voltage sags. One drawback of attempting to maintain the output welding power during input voltage sags via these mechanisms is that they necessarily increase the input current, resulting in more frequency nuisance tripping of circuit breakers or fuses at the input side and increasing the risk of rectifier failures in the AC/DC power converter circuit. Ongoing welding operations are disrupted and need to be terminated or restarted when the AC input power from AC mains or a generator is interrupted for even brief intervals of time.

Moreover, AC input power may be temporarily interrupted, and in some remote settings, supplying AC input power to a welding power source via AC mains or by a generator may be impractical. In all of the foregoing scenarios, it would be desirable to have another source of input power to the welding power source to supplement the available AC input power or to temporarily replace the AC input power when unavailable.

### SUMMARY

According to one implementation described herein, a hybrid welding power system comprises: an AC/DC converter to generate a rectified voltage from AC input power; a boost circuit to generate a DC link voltage from the rectified voltage; an inverter to generate a transformer input from the DC link voltage in accordance with a welding operation; a high-frequency (HF) transformer to receive the transformer input and generate a transformer output having current and voltage characteristics suitable for the welding operation; a secondary rectifier to rectify the transformer output to generate output welding power to be supplied to a weld output of the welding power system; and a battery power converter to couple a battery to the weld output to enable discharging of the battery to the weld output.

In one aspect, the battery power converter comprises a second inverter to receive DC battery power and to generate a second transformer input in accordance with the welding operation; a second HF transformer to receive the second transformer input and to generate a second transformer output having current and voltage characteristics suitable for a welding operation; and a second secondary rectifier to rectify the second transformer output to generate output welding power to be supplied to the weld output.

In another aspect, the battery power converter comprises a DC-DC buck converter to down-convert the DC link voltage to a battery charging voltage that is supplied to the battery for charging.

In yet another aspect, the battery power converter comprises a four quadrant converter to couple the battery to the weld output, wherein, in a charging mode, current flows from the weld output to the battery and the four quadrant converter operates as a DC-DC buck converter and, in a discharging mode, current flows from the battery to the weld output and the four quadrant converter operates as a DC-DC boost converter.

The hybrid welding power system is operable in a welding boost mode in which the output welding power includes power derived from the AC input power combined with power from the battery and is operable in a hybrid welding/charging mode in which the battery is charged and the output welding power is supplied to the weld output for the welding operation simultaneously.

According to another implementation, a hybrid welding power system comprises: an AC/DC converter to generate a rectified voltage from AC input power; a boost circuit to generate a DC link voltage from the rectified voltage; an inverter to generate a transformer input from the DC link voltage in accordance with a welding operation; a high-frequency (HF) transformer to receive the transformer input and generate a transformer output having current and voltage characteristics suitable for the welding operation; a secondary rectifier to rectify the transformer output to generate output welding power to be supplied to a weld output of the welding power system; and a battery power converter to couple a battery to the hybrid welding power system at a DC link upstream of the inverter to enable discharging of the battery to the DC link.

In one aspect, the battery power converter comprises a DC-DC boost converter to couple the battery to the DC link to up-convert DC battery power to the DC link voltage.

In another aspect, the battery power converter comprises a second AC/DC converter to generate a second rectified voltage from an output of a secondary winding of the HF transformer and a DC-DC buck converter to down-convert the second rectified voltage to a battery charging voltage that is supplied to the battery for charging.

According to yet another implementation, a hybrid welding power system, comprises: an AC/DC converter to generate a rectified voltage from AC input power; a boost circuit to generate a DC link voltage from the rectified voltage; an inverter to generate a transformer input from the DC link voltage in accordance with a welding operation; a high-frequency (HF) transformer to receive the transformer input and generate a transformer output having current and voltage characteristics suitable for the welding operation; a secondary rectifier to rectify the transformer output to generate output welding power to be supplied to a weld output of the welding power system; and a battery power converter to couple a battery to a secondary winding of the HF transformer to enable discharging of the battery to the HF transformer.

In one aspect, the battery power converter comprises a DC-DC boost converter to up-convert DC battery power to a higher voltage and a second inverter to convert the up-converted DC battery power to high-frequency AC power that is supplied to the secondary winding of the HF transformer.

In another aspect, the battery power converter comprises a bi-directional DC-DC converter coupled to the battery and an H-bridge circuit coupled to the bi-directional DC-DC converter and to the secondary winding of the HF transformer. In a charging mode, current flows from the secondary winding of the HF transformer to the battery, the H-bridge operates as a rectifier, and the bi-directional DC-DC converter operates as a DC-DC buck converter. In a discharging mode, current flows from the battery to the secondary winding of the HF transformer, and the bi-directional DC-DC converter operates as a DC-DC boost converter.

In yet another aspect, the battery power converter comprises a DC-DC buck converter to down-convert the DC link voltage to a battery charging voltage that is supplied to the battery for charging.

In still another aspect, the battery power converter comprises a second AC/DC converter to generate a second rectified voltage from the AC input power and a DC-DC buck converter to down-convert the second rectified voltage to a battery charging voltage that is supplied to the battery for charging.

According to still another implementation, a hybrid welding power system comprises: an AC/DC converter to generate a rectified voltage from AC input power; a boost circuit to generate a DC link voltage from the rectified voltage; an inverter to generate a transformer input from the DC link voltage in accordance with a welding operation; a high-frequency (HF) transformer to receive the transformer input and generate a transformer output having current and voltage characteristics suitable for the welding operation; a secondary rectifier to rectify the transformer output to generate output welding power to be supplied to a weld output of the welding power system; a brake resistor coupled between the secondary rectifier and the weld output to develop a brake resistor potential during short-circuit periods of the welding operation; and a battery power converter to couple the brake resistor to a battery to enable charging of the battery during short-circuit periods of the welding operation.

In one aspect, the battery power converter comprises an H-bridge circuit to couple the battery to a secondary winding of the HF transformer. In another aspect, the battery power converter comprises a bi-directional DC-DC converter circuit to couple the battery to the weld output and to the brake resistor.

The above and still further features and advantages of the described system will become apparent upon consideration of the following definitions, descriptions and descriptive figures of specific implementations thereof wherein like reference numerals in the various figures are utilized to designate like components. While these descriptions go into specific details, it should be understood that variations may and do exist and would be apparent to those skilled in the art based on the descriptions herein.

### BRIEF DESCRIPTION OF THE DRAWINGS

FIG. 1A is a block diagram of a first implementation of a hybrid power welding system employing a DC link connection architecture in which a battery is coupled to the DC link upstream of the welding power control circuitry via a buck converter for charging, and directly coupled to the weld output via separate, parallel welding power control circuitry.

FIG. 1B is a schematic representation of the hybrid power welding system employing the DC link connection architecture shown in FIG. 1A.

FIG. 1C illustrates the different modes of operation in the hybrid power welding system shown in FIG. 1A.

FIG. 2A is a block diagram of a second implementation of a hybrid power welding system employing a DC link connection architecture in which a battery is coupled to the AC input via a buck converter for charging and to the DC link upstream of the welding power control circuitry for supplying welding power.

FIG. 2B is a schematic representation of the hybrid power welding system employing the DC link connection architecture shown in FIG. 2A.

FIG. 2C illustrates the different modes of operation in the hybrid power welding system shown in FIG. 2A.

FIG. 3A is a block diagram of a third implementation of a hybrid power welding system employing a DC link connection architecture in which a battery is linked to the secondary winding of a high-frequency transformer for charging and to the DC link upstream of the welding power control circuitry for supplying welding power.

FIG. 3B is a schematic representation of the hybrid power welding system employing the DC link connection architecture shown in FIG. 3A.

FIG. 3C illustrates the different modes of operation in the hybrid power welding system shown in FIG. 3A.

FIG. 4A is a block diagram of a hybrid power welding system employing a direct weld output connection architecture in which a battery is coupled directly to the weld output via a four-quad boost-buck converter.

FIG. 4B is a schematic representation of the hybrid power welding system employing the direct weld output connection architecture shown in FIG. 4A.

FIG. 4C illustrates the different modes of operation in the hybrid power welding system shown in FIG. 4A.

FIG. 5A is a block diagram of a first implementation of a hybrid power welding system employing a high-frequency transformer coupling architecture in which a battery is charged and discharged via a bi-directional coupling to a secondary winding of the transformer.

FIG. 5B is a schematic representation of the hybrid power welding system employing the high-frequency transformer coupling architecture shown in FIG. 5A.

FIG. 5C illustrates the different modes of operation in the hybrid power welding system shown in FIG. 5A.

FIG. 6A is a block diagram of a second implementation of a hybrid power welding system employing a high-frequency transformer coupling architecture in which a battery is coupled to the DC link upstream of the welding power control circuitry via a buck converter for charging and to a secondary winding of the transformer to supply welding power.

FIG. 6B is a schematic representation of the hybrid power welding system employing the high-frequency transformer coupling architecture shown in FIG. 6A.

FIG. 6C illustrates the different modes of operation in the hybrid power welding system shown in FIG. 6A.

FIG. 7A is a block diagram of a third implementation of a hybrid power welding system employing a high-frequency transformer coupling architecture in which a battery is linked to the AC input via a buck converter for charging and to a secondary winding of the transformer to supply welding power.

FIG. 7B is a schematic representation of the hybrid power welding system employing the high-frequency transformer coupling architecture shown in FIG. 7A.

FIG. 7C illustrates the different modes of operation in the hybrid power welding system shown in FIG. 7A.

FIG. 8A is a schematic representation of a hybrid power welding system employing an architecture in which excess energy dissipated in a brake resistor is diverted to charge the battery.

FIG. 8B illustrates a current flow scenario with the brake resistor mechanism of FIG. 8A.

FIGS. 8C and 8D illustrate different current flow scenarios with the brake resistor mechanism of FIG. 8A.

### DETAILED DESCRIPTION

The described hybrid power welding system comprises three major components: a battery, a battery power converter, and a main welding power source. As used herein, the term “battery” means any type of charge storage device. The “battery” may comprise a plurality of individual batteries housed in a caddy, battery box, rack, etc. and electrically coupled together, e.g., in series or in parallel, to provide DC battery power to the welding power source via the battery power converter. The battery can be, for example, a plurality of power tool batteries. The battery power supplied by the battery can have a regulated or unregulated voltage depending on the capabilities of the battery power converter. According to one implementation, the battery (e.g., batteries in a battery box) is capable of delivering a specified DC voltage level, e.g., 60V to 80V, and has a specified total battery capacity, e.g., 6 AH to 15 AH.

The main welding power source is configured to receive AC power from AC mains or from a generator in addition to receiving DC power from the battery via the battery power converter. As described below, the main welding power source uses one or a combination of the AC power and battery power to generate output welding power for a welding system. As used herein the terms “weld” and “welding” refer to any of a wide range of welding and plasma cutting systems including but not limited to MIG/MAG, TIG, MMA (stick), and SAW welding systems. While the simplified circuit diagram shown herein supplies DC power to the weld output, it will be appreciated that the welding power source optionally may include a DC/AC converter downstream of the secondary rectifier to enable delivery of AC power for certain welding operation, e.g., AC TIG. The main welding power source also enables charging of the battery via the battery power converter using power derived from the AC input power. Described below are several architectures of the battery power converter for enabling charging and discharging of the battery.

The hybrid power welding system is designed to operate in several modes of operation:
Mode 1—welding mode. In this mode, the output welding power is generated only from AC input power (e.g., AC mains or generator power) by converting the AC input power to a DC voltage, and conditioning the DC voltage via welding power control circuitry (e.g., an inverter, a high-frequency transformer, and a secondary rectifier) to supply output welding power at a weld output of the welding power source.
Mode 2—charging mode. In this mode, the battery is charged from power derived from the AC input power and supplied to the battery via the battery power converter from some point in the power chain in the main welding power source.
Mode 3—hybrid welding-charging mode. In this mode, the output welding power is again supplied exclusively from the AC input power (as in Mode 1), and the battery is simultaneously charged from power derived from the AC input power (as in Mode 2).
Mode 4—welding boost mode. In this mode, the output welding power is simultaneously supplied by both the AC input power via the welding power control circuitry (as in Mode 1) and the battery via the battery power converter.
Mode 5—hybrid welding mode. In this mode, the battery is charged from power derived from the AC input power (as in Mode 2) and the output welding power is simultaneously supplied by the battery via discharging through the battery power converter. Note that Mode 5 is feasible only where the architecture of the battery power converter includes separate paths to the main welding power source for charging and discharging the battery.
Mode 6—battery welding mode. In this mode, the output welding power is supplied only by the battery via the battery power converter's coupling to the main welding power source.
Mode 7—trickle charge mode. This mode is similar to Mode 2 (charging mode), except that the welding power source is in an idle mode or standby mode in which the amount of power drawn by the power source is kept below a specified low-power level, thereby significantly reducing the amount of power is available for charging. For purposes of this disclosure, the description of Mode 2 (charging mode) is also applicable to Mode 7 (trickle charge mode) with the primary difference being the power available for charging.

A number of design architectures for the battery power converter are described. These concepts are organized into three groups based on the basic connection arrangement of the battery power converter in the main welding power source:
DC link connection: In this type of architecture, the battery is either charged or discharged (or both) via a coupling to the DC link upstream of the welding power control circuitry in the main welding power source.
Direct weld output connection. In this type of architecture, the battery is either charged or discharged (or both) via a coupling to the weld output downstream of the welding power control circuitry.
Direct High-Frequency (HF) transformer coupling. In this type of architecture, the battery is either charged or discharged or both via a coupling to either the primary or secondary winding of a high-frequency (HF) transformer in the welding power control circuitry that conditions the AC input power.

Also disclosed in a technique for diverting excess energy normally dissipated in a brake resistor during short-circuit operation to supplement battery charging.

### 1. Direct DC Link Connected Architectures

Described below are three implementations of direct DC link connected architectures of the battery power converter in which the battery is either charged or discharged via a coupling to a DC link upstream of the welding power control circuitry in the main welding power source.

A. Buck Converter from DC Link for Charging and Direct Weld Output from Battery

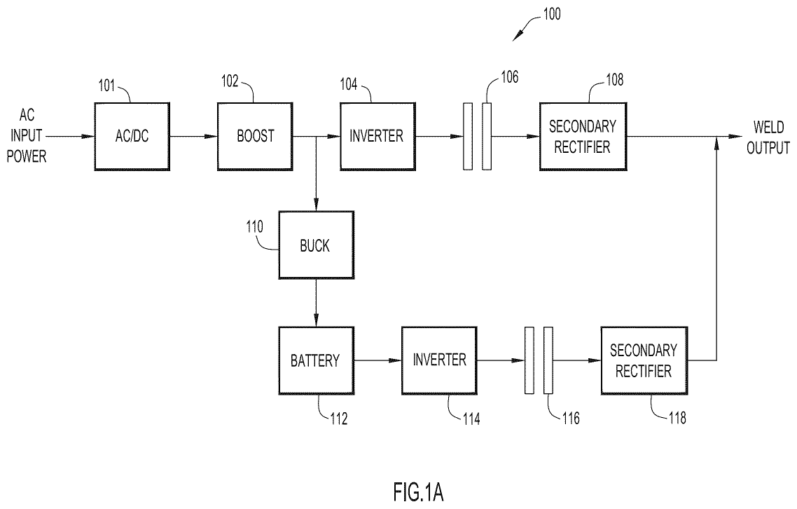

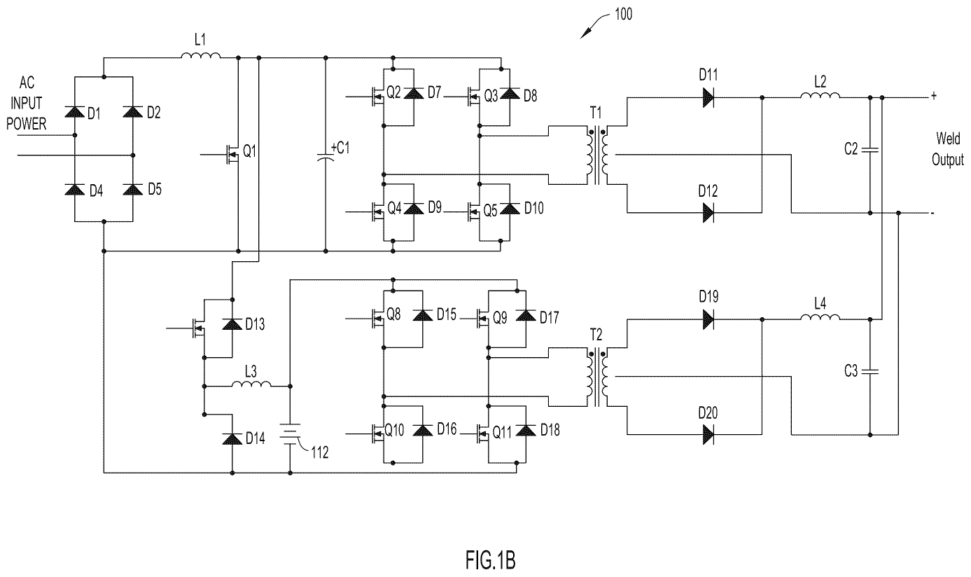

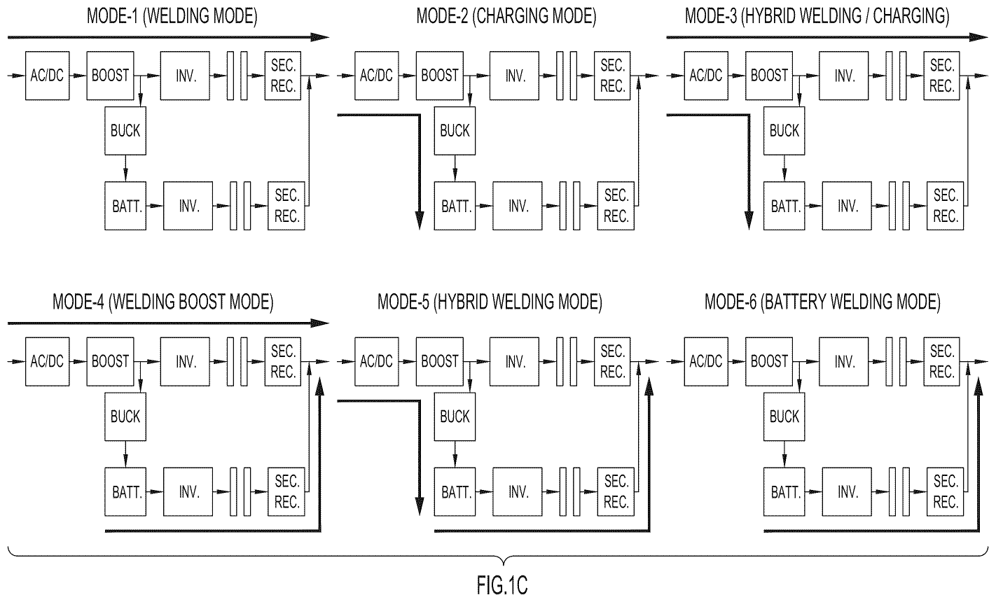

FIG. 1A is a block diagram of a first implementation of a hybrid power welding system 100 with a battery power converter employing a DC link connection architecture in which the battery is coupled to the DC link upstream of the welding power control circuitry via a buck converter for charging and is coupled to the weld output via second, parallel welding power control circuitry. FIG. 1B is a schematic representation (circuit diagram) of the hybrid power welding system 100 employing the DC link connection architecture shown in FIG. 1A. In the architecture shown in FIG. 1A, there is no bi-directional current flow anywhere in the system.

According to a high-level functional representation shown in FIG. 1A, the main welding power source includes an AC/DC converter 101, such as an AC/DC diode rectifier that receives AC input power (e.g., from AC mains or a generator) and generates a rectified DC voltage therefrom. In the simplified circuit diagram of FIG. 1B, AC/DC converter 101 comprises a diode bridge rectifier including a first diode D1 connecting the hot AC input to the positive DC output, a second diode D2 connecting the neutral AC input to the positive DC output, a third diode D4 connecting the hot AC input to ground, and a fourth diode D5 connecting the neutral AC input to ground. When the polarity of the AC input power is positive, diodes D1 and D5 respectively connect the hot and neutral lines of the AC input to the positive and ground outputs, respectively, whereas when the polarity of the AC power is negative, diodes D4 and D2 respectively connect the hot and neutral lines of the AC input to the ground and positive outputs, such that the output of AC/DC converter 101 is continuously a positive voltage.

Referring again to FIG. 1A, a boost circuit 102, boosts the rectified DC voltage supplied by AC/DC converter 101 to a higher voltage. Boost circuit 102 can be a DC-DC boost converter circuit that generates a regulated voltage, for example. According to one non-limiting option, boost circuit 102 can be a power factor correction (PFC) circuit. As shown in FIG. 1B, a simplified example of a boost circuit 102 includes an inductor L1 arranged along the positive line, a switching element Q1, such as a transistor or IGBT, coupled between the positive input and ground, and a capacitor C1 arranged in parallel with the switching element Q1. By switching the switching element Q1 on and off at a specified frequency, boost circuit 102 operates in a known manner to up-convert a lower-voltage DC input signal to higher-voltage DC output signal. The output of boost circuit 102 serves as a DC link, which can be a regulated voltage, e.g., 400 V, that is maintained at a specified DC link voltage level over a range of AC input power conditions.

The DC link voltage is supplied to the welding power control circuitry, which includes an inverter 104 (e.g., an H-bridge inverter), a high-frequency (HF) transformer 106, and an output (secondary) rectifier 108, which supplies welding power at the weld output to downstream welding equipment (e.g., a wire feeder, a welding gun or torch, a plasma torch, etc.). A weld process controller (not shown) controls inverter 104, e.g., via pulse width modulation, to control the output welding power during a welding process.

As shown in FIG. 1B, the H-bridge of inverter 104 comprises four switching elements Q2, Q3, Q4, and Q5, such as IGBTs. Diodes D7, D8, D9, and D10 are respectively arranged in parallel with the four switching elements. Switching element Q2 is coupled between the positive DC link line and a second end tap of the primary winding of HF transformer 106, switching element Q3 is coupled between the positive DC link link and a first end tap of the primary winding of HF transformer 106, switching element Q4 is coupled between the DC link ground and the second end tap of the primary winding of HF transformer 106, and switching element Q5 is coupled between the DC link ground and the first end tap of the primary winding of HF transformer 106. The gates of switching elements Q2-Q5 are controlled in a known manner by the weld process controller to convert the DC link voltage to a high-frequency AC power signal that is supplied as a transformer input to the primary winding of HF transformer 106 in accordance with a welding operation. Specifically, the weld process controller switches the gates of switching elements Q2-Q5 on and off at a high frequency to create a substantially square-wave AC signal suitable for transformation by HF transformer 106. Pulse width modulation of the gate control signals can be used to control the output welding power during a welding operation. HF transformer 106 generates a transformer output at its secondary winding having current and voltage characteristics suitable for the welding operation.

Secondary rectifier 108 rectifies the transformer output to generate output welding power to be supplied to the weld output of welding power system 100 of FIG. 1A and is represented in the simplified circuit diagram of FIG. 1B by diodes D11 and D12, inductor L2, and capacitor C2. Specifically, diode D11 is connected at its upstream end to one end tap of the secondary winding of HF transformer 106, and diode D12 is connected at its upstream end to the other end tap of the secondary winding of HF transformer 106. The downstream ends of diodes D11 and D12 are both connected to a common node coupled to an input end of inductor L2. Inductor L2 is arranged along the positive weld output line and is connected on its downstream end to the positive terminal of the weld output. The center tap of the secondary winding of HF transformer 106 is connected to the negative line of the weld output. Capacitor C2 is connected across the weld output, extending from the downstream end of inductor L2 to the negative line of the weld output. Diodes D11 and D12 provide rectification of the high-frequency output of HF transformer 106, while inductor L2 and capacitor C2 further smooth and filter the output welding power.

In the implementation shown in FIG. 1A, the battery power converter includes a DC-DC buck converter 110 that couples a battery 112 to the DC link upstream of the welding power control circuitry. Buck converter 110 receives power from the DC link at a higher voltage (e.g., 400 VDC) and down-converters (decreases) the voltage to a lower level (e.g., 60 VDC) suitable for charging battery 112. In the circuit diagram of FIG. 1B, buck converter 110 includes a switching element Q6 arranged in series with a diode D14 between the positive line of the DC link and ground. Another diode D13 is connected in parallel across switching element Q6. The positive terminal of battery 112 is connected to a node between switching element Q6 and diode D14 by an inductor L3. By switching the switching element Q6 of buck converter 110 on and off at a specified frequency, buck converter 110 operates in a known manner to down-convert the higher-voltage DC input signal from the DC link to a lower-voltage DC output signal at the positive terminal of battery 112 to enable charging of battery 112 from the DC link.

Referring once again to FIG. 1A, the battery power converter further includes second welding power control circuitry arranged parallel to the main welding power control circuitry and comprises a second inverter 114 (e.g., H-bridge inverter), a second HF transformer 116, and a second, secondary rectifier 118, which is coupled to the weld output. This second welding power control circuitry allows battery 112 to supply power to the weld output while simultaneously being charged via the upstream DC link.

More specifically, as shown in FIG. 1B, the H-bridge of second inverter 114 comprises four switching elements Q8, Q9, Q10, and Q11, such as IGBTs. Diodes D15, D16, D17, and D18 are respectively arranged in parallel with the four switching elements. Switching element Q8 is coupled between the positive terminal of battery 112 and a second end tap of the primary winding of second HF transformer 116, switching element Q9 is coupled between the positive terminal of battery 112 and a first end tap of the primary winding of second HF transformer 116, switching element Q10 is coupled between the battery ground terminal and the second end tap of the primary winding of second HF transformer 116, and switching element Q11 is coupled between the battery ground terminal and the first end tap of the primary winding of second HF transformer 116. The gates of switching elements Q8-Q11 are controlled by the weld process controller to convert the DC battery voltage to a high-frequency AC power signal that is supplied to the primary winding of second HF transformer 116 as a second transformer input. Specifically, the weld process controller switches the gates of switching elements Q8-Q11 on and off at a high frequency in accordance with a welding operation to create a substantially square-wave AC signal suitable for transformation by second HF transformer 116. Pulse width modulation of the gate control signals can be used to control the output welding power during a welding operation. Second HF transformer transforms the second transformer input to a second transformer output having current and voltage characteristics suitable for the welding operation.

Note that the input/output winding turn ratio of second HF transformer 116 of the battery power converter may differ from that of HF transformer 106. Specifically, HF transformer 106 receives at its primary winding the AC-converted DC link voltage, which is a higher voltage, e.g., 400 VDC. In contrast, second HF transformer 116 receives at its primary winding the AC-converted DC battery voltage, which is a lower voltage, e.g., 60 VDC. In order for the welding power from second HF transformer 116 to be at a comparable voltage level with the welding power from HF transformer 106, second HF transformer 116 may have a lower input/output turn ratio than HF transformer 106. By way of a non-limiting example, HF transformer 106 can be a step-down transformer with an input/output turn ratio of 400:60, whereas second HF transformer 116 can be a step-up transformer with an input/output turn ratio of 30:60.

Still referring to FIG. 1B, second secondary rectifier 118 of the battery power converter is represented by diodes D19 and D20, inductor L4, and capacitor C3. Specifically, diode D19 is connected at its upstream end to one end tap of the secondary winding of second HF transformer 116, and diode D20 is connected at its upstream end to the other end tap of the secondary winding of second HF transformer 116. The downstream ends of diodes D19 and D20 are both connected to a common node coupled to an input end of inductor L4. Inductor L4 is arranged along the positive weld output line of the battery power converter and is connected on its downstream end to the positive terminal of the weld output. The center tap of the secondary winding of second HF transformer 116 is connected to the negative line of the weld output. Capacitor C3 is connected across the weld output, extending from the downstream end of inductor L4 to the negative line of the weld output. Diodes D19 and D20 provide rectification of the high-frequency output of second HF transformer 116, while inductor L4 and capacitor C3 further smooth and filter the output welding power.

FIG. 1C illustrates the different modes of operation in the hybrid power welding system shown in FIGS. 1A and 1B. In welding mode (Mode 1), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output. During this mode, switches in the battery power converter circuitry (e.g., in buck converter 110 and/or second inverter 114) are in an “off” state such that battery 112 neither charges nor discharges.

In charging mode (Mode 2), the AC input power is supplied to AC/DC converter 101 to produce the rectified input voltage, which is then boosted by boost circuit 102 to a higher DC link voltage (e.g., 400 V). Inverter 104 and second inverter 114 are in an “off” state, such that neither the AC input power nor battery power is supplied to the weld output. In buck converter 110, switching element Q6 is switched at specified switching frequency to down-convert the DC link voltage to a suitable battery charging voltage (e.g., 60V) to regulate charging of battery 112.

In hybrid welding/charging mode (Mode 3), the AC input power is supplied to AC/DC converter 101 to produce the rectified input voltage, which is then boosted by boost circuit 102 to a higher DC link voltage (e.g., 400 V). Inverter 104 is switched at a high frequency to supply high-frequency AC power to HF transformer 106, and secondary rectifier 108 delivers the welding power to the weld output. Second inverter 114 is turned “off” such that battery power is not discharged or supplied to the weld output. Simultaneously, in buck converter 110, switching element Q6 is switched at specified switching frequency to receive a portion of the power available at the DC link, and down-convert the DC link voltage to a suitable battery charging voltage (e.g., 60V) to regulate charging of battery 112.

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power HF transformer 106, and secondary rectifier 108 delivers the welding power to the weld output. Buck converter 110 is turned “off” (e.g., by controlling switching element Q6) such that power does not flow from the DC link to charge battery 112. Simultaneously, second inverter 114 is switched in synchronization with inverter 104 to supply battery power to the weld output via second HF transformer 116 and second secondary rectifier 118. The main and battery currents are summed at the weld output. The synchronization of currents between the two converters are managed by the weld process controller.

In hybrid welding mode (Mode 5), the AC input power is supplied to AC/DC converter 101 to produce the rectified input voltage, which is then boosted by boost circuit 102 to a higher DC link voltage (e.g., 400 V). Inverter 104 is in an “off” state, such that power from the AC input is not supplied to the weld output via the main welding power control circuitry. Simultaneously, in buck converter 110, switching element Q6 is switched at specified switching frequency to down-convert the DC link voltage to a suitable battery charging voltage (e.g., 60V) to regulate charging of battery 112. Second inverter 114 is switched at high frequency to discharge battery 112 and supply battery power to the weld output via second HF transformer 116 and second secondary rectifier 118.

In battery welding mode (Mode 6), AC input power is not supplied to AC/DC converter 101, and inverter 104 is in an “off” state, such that power is not supplied to the weld output via the main welding power control circuitry. Second inverter 114 is switched at high frequency to discharge battery 112 and supply battery power to the weld output via second HF transformer 116 and second secondary rectifier 118.

A summary of the modes of operation for the first implementation of the direct DC link connected architecture described in connection with FIGS. 1A-1C is provided in Table 1 below.

TABLE 1

| Modes of Operation | Description |
|---|---|
| 1. Welding Mode | AC input power routed through inverter to weld output |
| 2. Charging Mode | AC input power routed through buck converter to charge the |
| | battery |
| 3. Hybrid Welding/Charging Mode | AC input power routed through inverter to weld output and routed |
| | through buck converter to charge the battery (Modes 1 & 2) |
| 4. Welding Boost Mode | AC input power routed through inverter to weld output and battery |
| | power routed through second inverter to weld output (modes 1 & |
| | 6) |
| 5. Hybrid Welding Mode | AC input power routed through buck converter to charge the |
| | battery and battery power routed through second inverter to weld |
| | output (modes 2 & 6) |
| 6. Battery Welding Mode | Battery power routed through second inverter to weld output |

B. Charge Via Buck Converter from AC Input/Discharge Via Boost Converter to DC Link

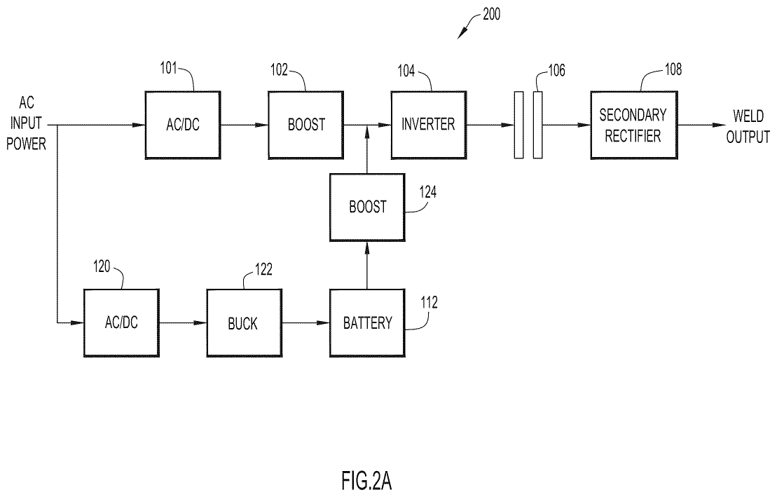

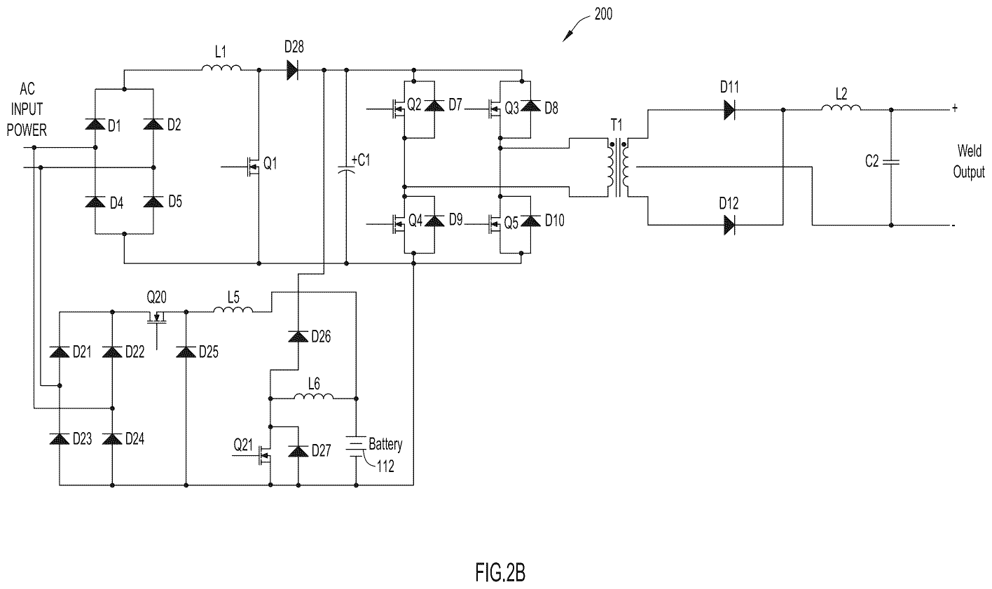

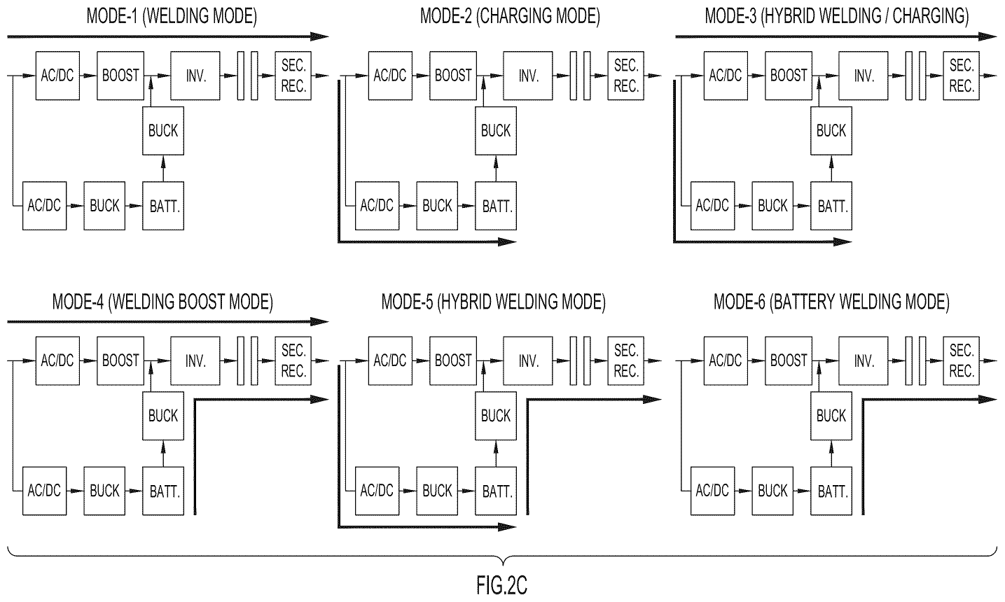

FIG. 2A is a block diagram of a second implementation of a hybrid power welding system 200 with a battery power converter employing a DC link connection architecture in which the battery is coupled to the AC input power via a buck converter for charging and to the DC link upstream of the welding power control circuitry via a boost converter for discharging to supply welding power. FIG. 2B is a schematic representation (circuit diagram) of the hybrid power welding system 200 employing the DC link connection architecture shown in FIG. 2A. In the architecture shown in FIG. 2A, there is no bi-directional current flow anywhere in the system.

The components of the main welding power source in FIG. 2A are the same as those in FIG. 1A, i.e., AC/DC converter 101, boost circuit 102, and the main welding power control circuitry, which includes inverter 104, HF transformer 106, and secondary rectifier 108, which supplies welding power at the weld output to downstream welding equipment.

In the implementation shown in FIG. 2A, the battery power converter includes a second AC/DC converter 120, such as another diode rectifier that receives the AC input power and is arranged in parallel with AC/DC converter 101 of the main welding power supply. When supplied from the AC input power, second AC/DC converter 120 generates a second rectified DC voltage from the AC input power, which is supplied to a DC-DC buck converter 122 that converters (decreases) the voltage of the rectified output of second AC/DC converter 120 to a lower voltage level (e.g., 60 V) suitable for charging battery 112. The battery power converter further comprises a DC-DC boost converter 124 that couples battery 112 to the DC link upstream of the welding power control circuitry. Boost converter 122 receives power from battery 112 and up-converts (increases) the voltage of the battery power to the voltage level of the DC link (e.g., 400 V) such that battery power can be discharged via the DC link.

As shown in the simplified circuit diagram of FIG. 2B, second AC/DC converter 120 comprises a diode bridge rectifier including a first diode D21 connecting the hot AC input to a positive DC output, a second diode D22 connecting the neutral AC input to the positive DC output, a third diode D23 connecting the hot AC input to ground, and a fourth diode D24 connecting the neutral AC input to ground. When the polarity of the AC input power is positive, diodes D21 and D24 respectively connect the hot and neutral lines of the AC input to the positive and ground outputs, whereas when the polarity of the AC power is negative, diodes D23 and D22 respectively connect the hot and neutral lines of the AC input to the ground and positive outputs, such that the output of second AC/DC converter 120 is continuously a positive voltage.

Buck converter 122 includes a switching element Q20 arranged in series with an inductor L5 along the positive DC line extending from second AC/DC converter 120 to the positive terminal of battery 112, and a diode D25 connected between ground and a node between switching element Q20 and inductor L5. By switching the switching element Q20 of buck converter 122 on and off at a specified switching frequency, buck converter 122 operates in a known manner to down-convert the higher-voltage rectified DC input signal from the AC input to a lower-voltage DC output signal at the positive terminal of battery 112 to enable charging of battery 112 from power flowing from the AC input.

Boost converter 124 includes a diode D26 connected at one end to the positive line of the DC link, downstream of a diode D28 arranged along the positive line of the DC link arranged in series with inductor L1. Diode D26 is arranged in series with a switching element Q21 between the positive line of the DC link and ground. Another diode D27 is connected in parallel across switching element Q21. The positive terminal of battery 112 is connected to a node between switching element Q21 and diode D26 by an inductor L6. By switching the switching element Q21 of boost converter 124 on and off at a specified switching frequency, boost converter 124 operates in a known manner to up-convert the lower-voltage DC input signal from battery 112 to a higher-voltage DC output signal at the positive line of the DC link to enable discharging of battery 112 to the DC link.

FIG. 2C illustrates the different modes of operation in the hybrid power welding system shown in FIGS. 2A and 2B. In welding mode (Mode 1), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output. During this mode, switches in the battery power converter circuitry (e.g., in buck converter 122 and boost converter 124) are in an “off” state such that battery 112 neither charges nor discharges.

In charging mode (Mode 2), the AC input power is supplied to second AC/DC converter 120 to produce a rectified DC voltage. In buck converter 122, switching element Q20 is switched at a specified switching frequency to down-convert the rectified DC voltage to a suitable battery charging voltage (e.g., 60V) to regulate charging of battery 112. The path through the main welding power source circuitry is switched to an “off” state in this mode (e.g., via switching elements in boost circuit 102 and inverter 104) such that the AC input power does not pass through the main welding power source circuitry. Likewise, boost converter circuit 124 can be switched off.

In hybrid welding/charging mode (Mode 3), a portion of the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power to HF transformer 106, and secondary rectifier 108 delivers the welding power to the weld output. Simultaneously, the remaining portion of the AC input power is supplied to second AC/DC converter 120 to produce a second rectified DC voltage. In buck converter 122, switching element Q20 is switched at a specified switching frequency to down-convert the rectified DC voltage to a suitable battery charging voltage (e.g., 60V) to regulate charging of battery 112. Boost converter circuit 124 is switched off to prevent battery power from discharging to the DC link.

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power to the primary winding of HF transformer 106, and secondary rectifier 108 delivers the welding power to the weld output. Simultaneously, in the battery power converter, buck converter 122 that supplies charging power to battery 112 is switched to an “off” state, while boost converter 124 coupling battery 112 to the DC link is switched to an “on” state. Specifically, switching element Q21 of boost converter 124 is switched at a specified frequency and up-converts the battery voltage to match the DC link voltage (e.g., 400V). When switching element Q21 is turned on, the current from battery 112 flows through inductor L6 and the switching element Q21. When switching element Q21 is turned off, the stored energy in inductor L6 is added to the battery voltage and connects to the DC link through diode D26 (see FIG. 2B). Inverter 104, HF transformer 106, and secondary rectifier 108 will then deliver welding power derived from both the AC input power and battery 112 to the weld output. The synchronization of the two boost circuits 102, 124 can be managed by sensing the current via sensors in both the DC link and the battery converter.

In hybrid welding mode (Mode 5), boost circuit 102 is in an “off” state such that AC input power does not reach the DC link via the main welding power control circuitry path. The AC input power is supplied to second AC/DC converter 120 of the battery power converter to produce a second rectified DC voltage. In buck converter 122, switching element Q20 is switched at a specified switching frequency to down-convert the rectified DC voltage to a suitable battery charging voltage (e.g., 60V) to regulate charging of battery 112. Simultaneously, boost converter 124 coupling battery 112 to the DC link is switched to an “on” state. Specifically, switching element Q21 of boost converter 124 is switched at a specified frequency and up-converts the battery voltage to the desired DC link voltage (e.g., 400V) and delivers the boosted DC power to the DC link. Inverter 104, HF transformer 106, and secondary rectifier 108 then deliver welding power derived from battery 112 to the weld output.

In battery welding mode (Mode 6), AC input power is not supplied. In boost converter 124 of the battery power converter, switching element Q21 of boost converter 124 is switched at a specified frequency and up-converts the battery voltage to the desired DC link voltage (e.g., 400V) and delivers the boosted DC power to the DC link Inverter 104, HF transformer 106, and secondary rectifier 108 then deliver welding power derived from battery 112 to the weld output.

A summary of the modes of operation for the second implementation of the direct DC link connected architecture described in connection with FIGS. 2A-2C is provide in Table 2 below.

TABLE 2

| Modes of Operation | Description |
|---|---|
| 1. Welding Mode | AC input power routed through inverter to weld output |
| 2. Charging Mode | AC input power routed through buck converter to charge the |
| | battery |
| 3. Hybrid Welding/Charging Mode | AC input power routed through inverter to weld output and routed |
| | through buck converter to charge the battery (Modes 1 & 2) |
| 4. Welding Boost Mode | AC input power routed through inverter to weld output and battery |
| | power routed through inverter via boost converter to weld output |
| | (modes 1 & 6) |
| 5. Hybrid Welding Mode | AC input power routed through buck converter to charge the |
| | battery and battery power routed through inverter via boost |
| | converter to weld output (modes 2 & 6) |
| 6. Battery Welding Mode | Battery power routed through inverter via boost converter to weld |
| | output |

C. Charge Via HF Transformer/Discharge Via Boost Converter to DC Link

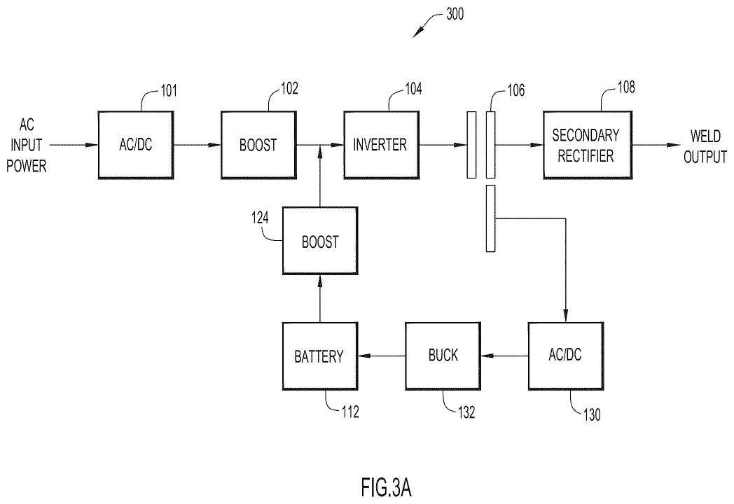

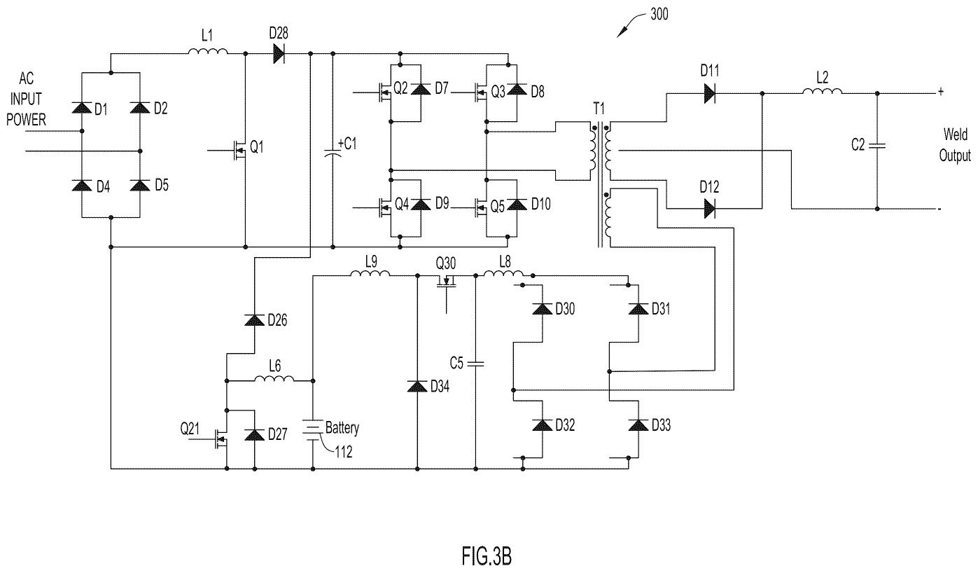

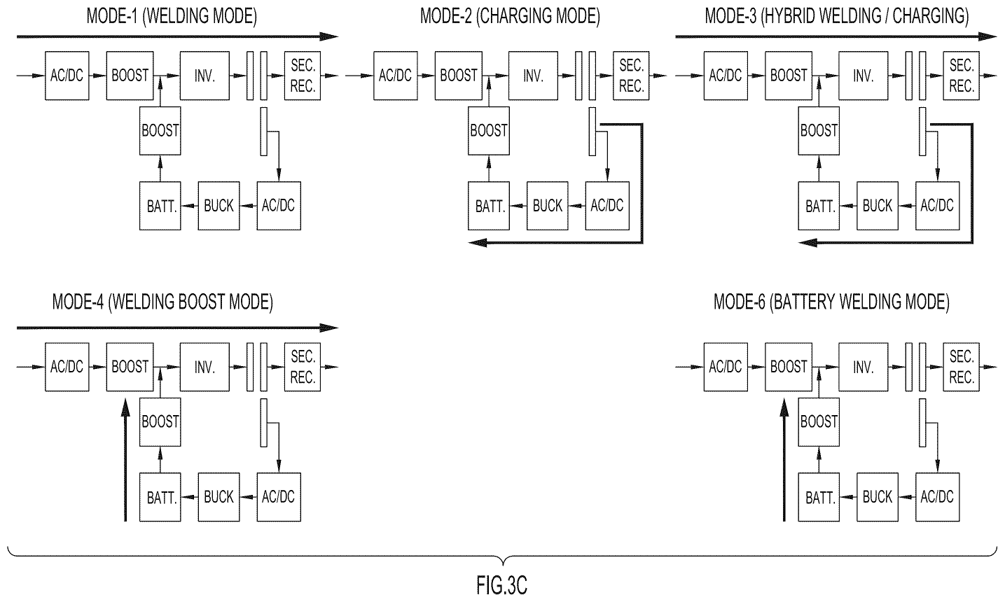

FIG. 3A is a block diagram of a third implementation of a hybrid power welding system 300 with a battery power converter employing a DC link connection architecture in which the battery is coupled to a secondary winding of the HF transformer via a buck converter for charging and to the DC link upstream of the welding power control circuitry via a boost converter for discharging to supply welding power. FIG. 3B is a schematic representation (circuit diagram) of the hybrid power welding system 300 employing the DC link connection architecture shown in FIG. 3A. In the architecture shown in FIG. 3A, there is no bi-directional current flow anywhere in the system.

The components of the main welding power source in FIG. 3A are similar to those in FIG. 1A, i.e., AC/DC converter 101, boost circuit 102, and the main welding power control circuitry, which includes inverter 104, HF transformer 106, and secondary rectifier 108, which supplies welding power at the weld output to downstream welding equipment. However, the HF transformer has dual secondary windings, a first of which is coupled to secondary rectifier 108 that supplies the weld output, and the second of which is coupled to the battery power converter. For example, the primary and secondary winding ratios can be selected as follows: primary:secondary1:secondary2=400:90:90.

In the implementation shown in FIG. 3A, the battery power converter includes a second AC/DC converter 130, such as another diode rectifier, which receives AC power from the second secondary winding of HF transformer 106. Second AC/DC converter 130 generates a second rectified DC voltage from the high-frequency AC power from HF transformer 106, which is supplied to a DC-DC buck converter 132 that down-converters (decreases) the voltage of the rectified DC voltage to a lower level (e.g., 60 V) suitable for charging battery 112. The battery converter further comprises a boost converter 124 that couples battery 112 to the DC link upstream of the welding power control circuitry. Boost converter 124 receives power from battery 112 and up-converts (increases) the voltage of the battery power to the voltage level of the DC link (e.g., 400 V).

As shown in the simplified circuit diagram of FIG. 3B, second AC/DC converter 130 comprises a diode bridge rectifier including a first diode D30 connecting a first end tap of the second secondary winding of HF transformer 106 to a positive DC output, a second diode D31 connecting a second end tap of the second secondary winding of HF transformer 106 to the positive DC output, a third diode D32 connecting the first end tap of the second secondary winding of HF transformer 106 to ground, and a fourth diode D33 connecting the second end tap of second secondary winding of HF transformer 106 to ground. When the polarity of the AC power from the transformer output is positive, diodes D30 and D33 respectively connect the first and second end taps of the second secondary winding of HF transformer 106 to the positive and ground outputs, respectively, whereas when the polarity of the AC power from the transformer output is negative, diodes D32 and D31 respectively connect the first and second end taps of the second secondary winding of HF transformer 106 to the ground and positive outputs, such that the second rectified output of second AC/DC converter 130 is continuously a positive voltage.

Buck converter 132 includes: an inductor L8, a switching element Q30, and an inductor L9 arranged in series along the positive DC line extending from second AC/DC converter 130 to the positive terminal of battery 112; a diode D34 connected between ground and the node between switching element Q30 and inductor L9; and a capacitor C5 extending from ground to the node between inductor L8 and switching element Q30. By switching the switching element Q30 of buck converter 132 on and off at a specified switching frequency, buck converter 132 operates in a known manner to down-convert the higher-voltage rectified DC voltage from the second secondary winding of HF transformer 106 to a lower-voltage DC output signal at the positive terminal of battery 112 to enable charging of battery 112 from power flowing from the AC input.

FIG. 3C illustrates the different modes of operation in the hybrid power welding system shown in FIGS. 3A and 3B. In welding mode (Mode 1), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output. During this mode, switches in the battery power converter circuitry (e.g., in buck converter 132 and boost converter 134) are in an “off” state such that battery 112 neither charges nor discharges.

In charging mode (Mode 2), the AC input power is supplied to AC/DC converter 101 to produce the rectified input voltage, which is then boosted by boost circuit 102 to a higher DC link voltage (e.g., 400 V). The DC link voltage is supplied to inverter 104, which is switched at high frequency to the primary of HF transformer 106. The reflected voltage from the second secondary winding of HF transformer 106 is supplied to second AC/DC converter 130 to produce a second rectified DC voltage. In buck converter 132, switching element Q30 is switched at a specified switching frequency to down-convert the rectified DC voltage to a suitable battery charging voltage (e.g., 60V) to regulate charging of battery 112. In this mode, boost converter 124 is switched to an “off” state. Because the battery voltage is always smaller than the DC link voltage, diode D26 will be reversed biased and decouple the DC link from battery 112.

In hybrid welding/charging mode (Mode 3), the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power to the primary of HF transformer 106. The reflected voltage from the first secondary winding of HF transformer 106 is rectified by secondary rectifier 108 and delivered to the weld output. Simultaneously, the reflected voltage from the second secondary winding of HF transformer 106 is supplied to second AC/DC converter 130 to produce a rectified DC voltage. In buck converter 132, switching element Q30 is switched at a specified switching frequency to down-convert the rectified DC voltage to a suitable battery charging voltage (e.g., 60V) to regulate charging of battery 112. In this mode, boost converter 124 is switched to an “off” state to prevent battery power from discharging to the DC link. As the battery voltage is always smaller than the DC link voltage, the diode D26 will be reversed biased and decouple the DC Link from battery 112.

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power to the primary winding of HF transformer 106. The reflected voltage from the first secondary winding of HF transformer 106 is rectified by secondary rectifier 108 and delivered to the weld output. Simultaneously in the battery power converter, buck converter 132 is switched to an “off” state and diodes D40-D43 of second AC/DC converter 130 block the current flow between the second secondary winding of HF transformer 106 and battery 112. Boost converter 124 coupling battery 112 to the DC link is switched to an “on” state. Specifically, switching element Q21 of boost converter 124 is switched at a specified frequency and up-converts the battery voltage to match the DC link voltage (e.g., 400V). Inverter 104, HF transformer 106, and secondary rectifier 108 will then deliver welding power derived from both the AC input power and battery 112 to the weld output. The synchronization of the two boost circuits 102, 124 can be managed by sensing the current via sensors in both the DC link and the battery power converter.

The hybrid welding mode (Mode 5) is not practical with the architecture of this implementation.

In battery welding mode (Mode 6), AC input power is not supplied. In boost converter 124 of the battery power converter, switching element Q21 of boost converter 124 is switched at a specified frequency and up-converts the battery voltage to the desired DC link voltage (e.g., 400V) and delivers the boosted DC power to the DC link Inverter 104, HF transformer 106, and secondary rectifier 108 then deliver welding power derived from battery 112 to the weld output.

A summary of the modes of operation for the fourth implementation of the direct DC link connected architecture described in connection with FIGS. 3A-3C is provided in Table 3 below.

TABLE 3

| Modes of Operation | Description |
|---|---|
| 1. Welding Mode | AC input power routed through inverter to weld output |
| 2. Charging Mode | AC power routed from secondary of HF transformer through buck |
| | converter to charge the battery |
| 3. Hybrid Welding/Charging Mode | AC input power routed through inverter to weld output and AC |
| | power routed from secondary of HF transformer through buck |
| | converter to charge the battery (Modes 1 & 2) |
| 4. Welding Boost Mode | AC input power routed through inverter to weld output and battery |
| | power routed through inverter via boost converter to weld output |
| | (modes 1 & 6) |
| 5. Hybrid Welding Mode | Not feasible |
| 6. Battery Welding Mode | Battery power routed through inverter via boost converter to weld |
| | output |

### 2. Direct Weld Output Connection Architecture—Four Quadrant Battery Converter to Weld Output

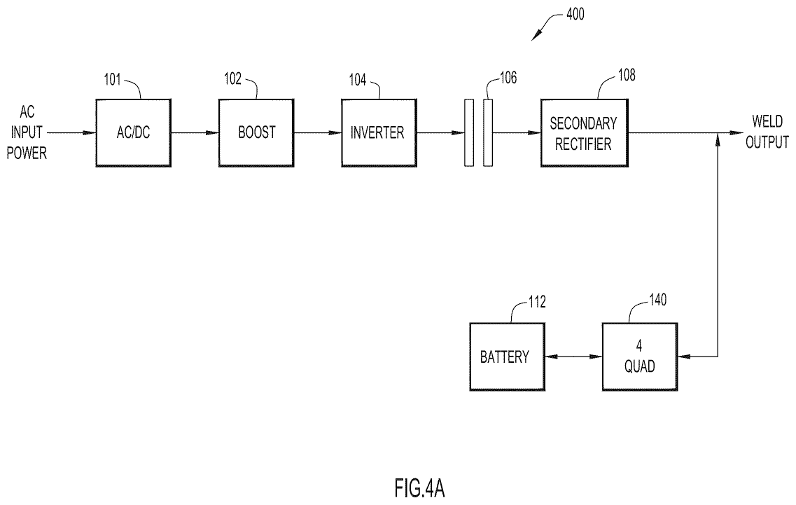

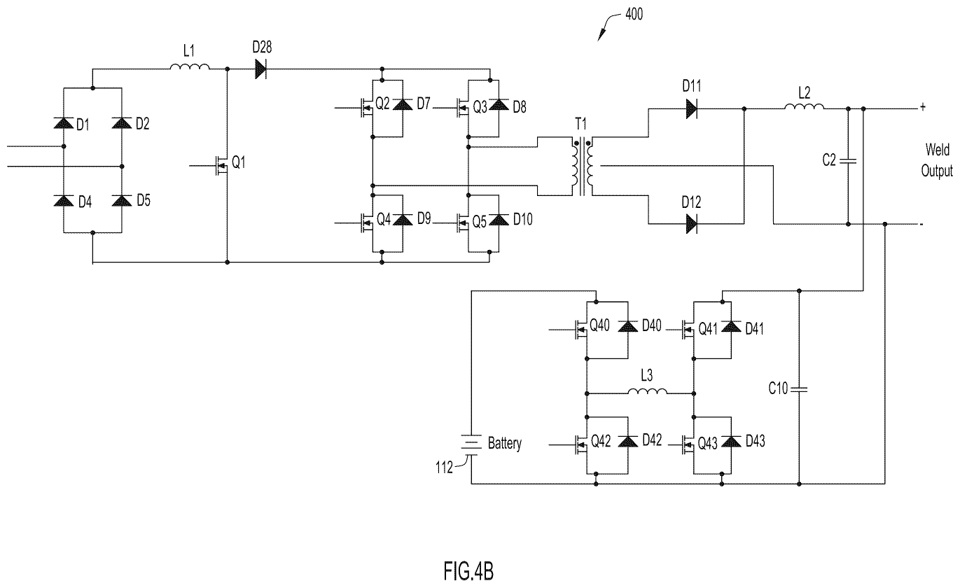

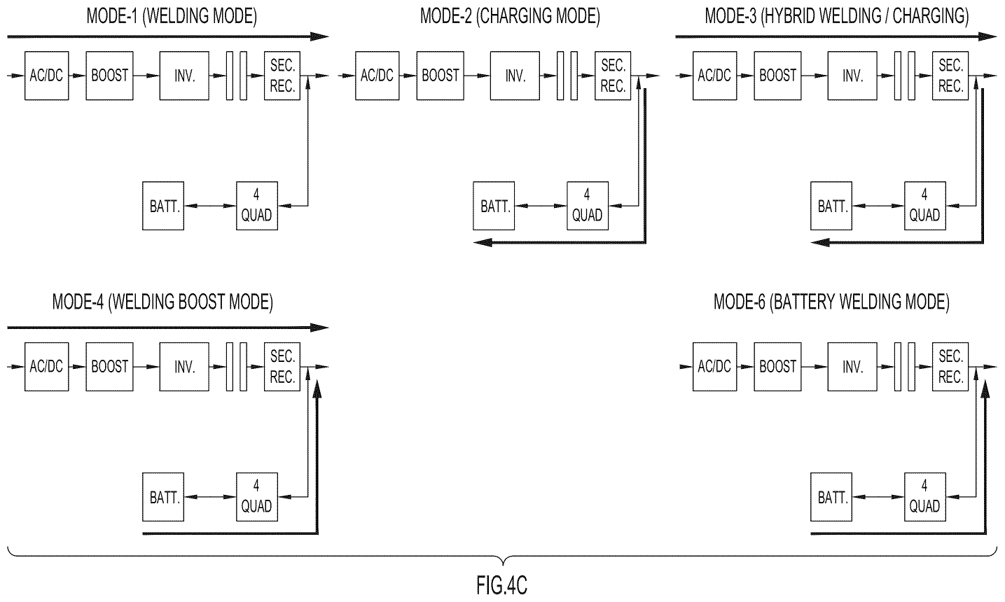

Described below is an implementation of a direct weld output connection architecture of the battery power converter in which the battery is coupled to the weld output via a four quadrant converter. Specifically, FIG. 4A is a block diagram of a hybrid power welding system 400 employing a direct weld output connection architecture in which a battery is coupled directly to the weld output via a four quadrant converter. FIG. 4B is a schematic representation of the hybrid power welding system 400 employing the direct weld output connection architecture shown in FIG. 4A.

In the architecture shown in FIG. 4A, bi-directional current flows between battery 112 and a four quadrant converter 140, such that both charging and discharging occur through four quadrant converter 140. Battery 112 is completely isolated from both the primary AC input power and the welding circuit.

The components of the main welding power source in FIG. 4A are the same as those in FIG. 1A, i.e., AC/DC converter 101, boost circuit 102, and the main welding power control circuitry, which includes inverter 104, HF transformer 106, and secondary rectifier 108, which supplies welding power at the weld output to downstream welding equipment. The battery power converter includes four quadrant converter 140 that couples the weld output to battery 112 bi-directionally.

As shown in the circuit diagram of FIG. 4B, four quadrant converter 140 comprises four switching elements Q40, Q41, Q42, and Q43, such transistors or IGBTs. Diodes D40, D41, D42, and D43 are respectively arranged in parallel with the four switching elements. Switching elements Q40 and Q42 are arranged in series between the positive terminal of battery 112 and the ground terminal of battery 112. Switching elements Q41 and Q43 are arranged in series between the positive and negative terminals of the weld output. Four quadrant converter 140 further comprises an inductor connecting a node between switching elements Q40 and Q42 with a node between switching elements Q41 and Q43. A capacitor C10 extends between the positive and negative output terminals of the weld output, in parallel with the series-connected switching elements Q41 and Q43.

FIG. 4C illustrates the different modes of operation in the hybrid power welding system shown in FIGS. 4A and 4B. In welding mode (Mode 1), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output. During this mode, the switching elements of four quadrant converter 140 are maintained in an “off” state such that battery 112 neither charges nor discharges.

In charging mode (Mode 2), the AC input power is supplied to AC/DC converter 101 to produce the rectified input voltage, which is then boosted by boost circuit 102 to a higher DC link voltage (e.g., 400 V), which is supplied to the main welding power control circuitry to provide an open circuit voltage (OCV) at the weld output. To charge battery 112 from the weld output, in four quadrant converter 140, switching element Q41 is switched at a specified switching frequency and regulates the battery voltage acting in a buck mode. When switching element Q41 is turned on, the current flow to battery 112 from the weld output takes place through switching element Q41, inductor L10, and diode D40. When switching element Q41 is turned off, the stored energy in inductor L10 is circulated through diode D40, battery 112, and diode D43.

In hybrid welding/charging mode (Mode 3), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, secondary rectifier 108 process the DC link voltage to deliver welding power to the weld output. To simultaneously charge battery 112 during this mode, four quadrant converter 140 is operated as follows. Switching element Q41 is kept on. Switching element Q42 is switched at a specified switching frequency and regulates the battery voltage acting in a boost mode. When switching element Q42 is turned on, the current flow from the weld output takes place through switching element Q41, inductor L10, and switching element Q42. When switching element Q42 is turned off, the stored energy in inductor L10 in addition to the weld output is delivered to battery 112, switching element Q41, inductor L10, and diode D40.

In welding boost mode (Mode 4), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output. To boost the output welding power with power from battery 112 during this mode, four quadrant converter 140 is operated simultaneously as follows. Switching element Q40 is switched at a specified switching frequency and regulates the battery output in buck mode and synchronizes with the weld output. When switching element Q40 is turned on, the current from battery 112 flows through switching element Q40, inductor L10, and diode D41. When switching element Q40 is turned off, the stored energy in inductor L10 is circulated through diode D41, the weld output, and diode D42.

The hybrid welding mode (Mode 5) is not feasible with the architecture shown in FIGS. 4A and 4B.

In battery welding mode (Mode 6), AC input power is not supplied to the system. To supply welding power from battery 112, four quadrant converter 140 is operated as follows. Switching element Q40 is switched at a specified switching frequency and regulates the battery output in buck mode and synchronizes with the weld output. When switching element Q40 is turned on, the current from battery 112 flows through switching element Q40, inductor L10, and diode D41. When switching element Q40 is turned off, the stored energy in inductor L10 is circulated through diode D41, the weld output, and diode D42. If the required weld voltage is higher than the battery voltage, switching element Q43 is switched at a specified switching frequency and regulates the weld output to the required level. At this condition, switching element Q40 is always kept on. When switching element Q43 is switched on, the current flow from battery 112 will take place through switching element Q43, inductor L10, and switching element Q41. When switching element Q43 is switched off, the stored energy from inductor L10 in addition to the battery voltage is delivered through battery 112, switching element Q40, inductor L10, and diode D41 to the weld output.

A summary of the modes of operation for the direct weld output connected architecture described in connection with FIGS. 4A-4C is provided in Table 4 below.

TABLE 4

| Modes of Operation | Description |
|---|---|
| 1. Welding Mode | AC input power routed through inverter to weld output |
| 2. Charging Mode | Battery charged from welding power routed from weld output to |
| | battery via 4 quadrant converter |
| 3. Hybrid Welding/Charging Mode | AC input power routed through inverter to weld output; battery |
| | charged from welding power routed from weld output to battery |
| | via 4 quadrant converter (Modes 1 & 2) |
| 4. Welding Boost Mode | AC input power routed through inverter to weld output and battery |
| | power routed through 4 quadrant converter to weld output (modes |
| | 1 & 6) |
| 5. Hybrid Welding Mode | Not feasible |
| 6. Battery Welding Mode | Battery power routed through 4 quadrant converter to weld output |

### 3. Direct High-Frequency (HF) Transformer Coupled Architectures

A. Charging and Discharging Through Secondary of HF Transformer

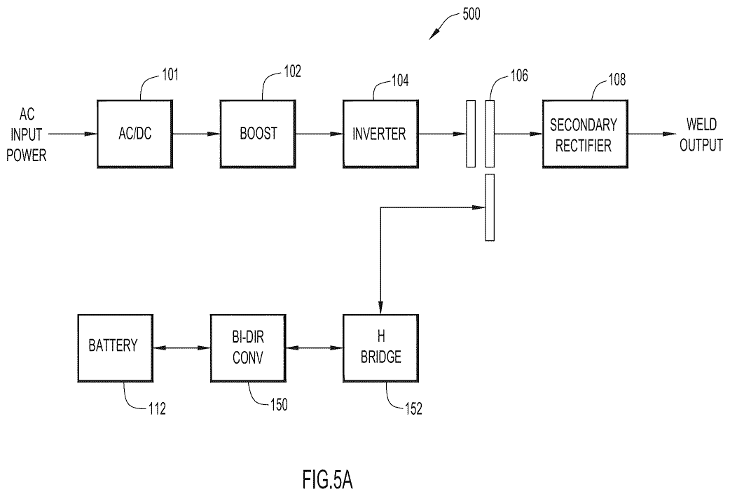

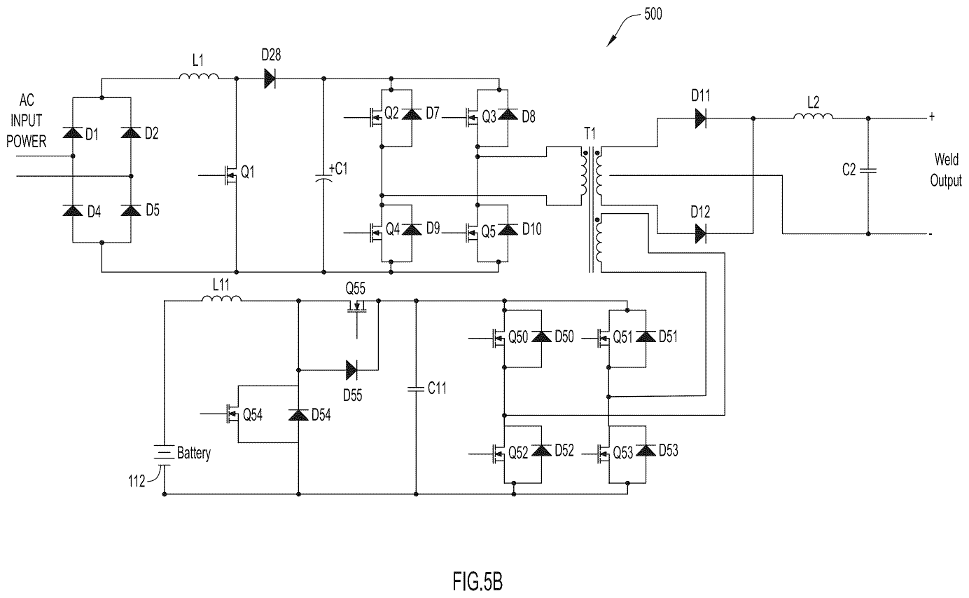

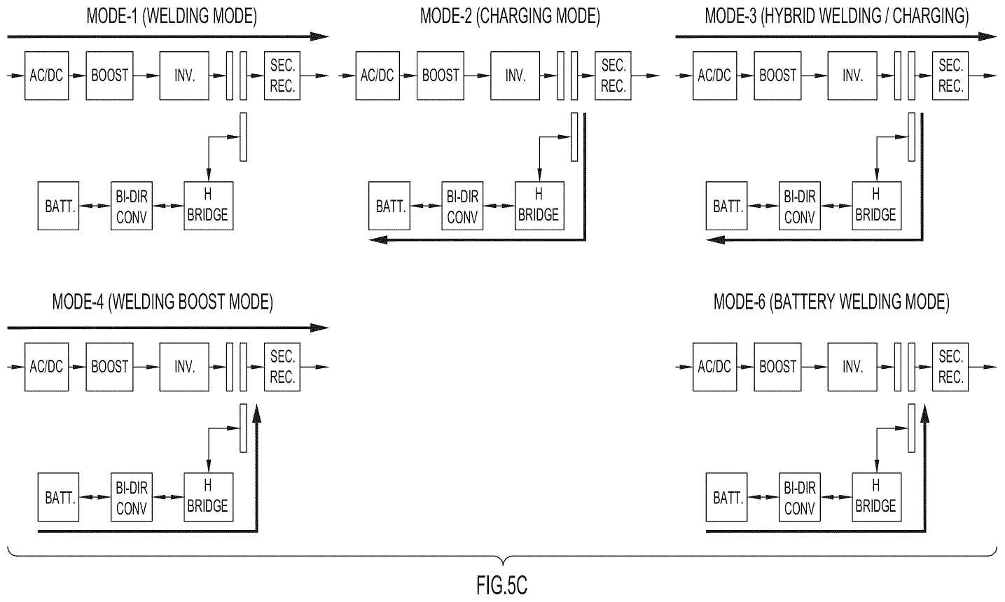

FIG. 5A is a block diagram of a first implementation of a hybrid power welding system 500 employing a high-frequency transformer coupling architecture in which a battery is charged and discharged via a bi-directional link to a secondary winding of the HF transformer. FIG. 5B is a schematic representation of the hybrid power welding system 500 employing the HF transformer coupling architecture shown in FIG. 5A.

The components of the main welding power source in FIG. 5A are similar to those in FIG. 1A, i.e., AC/DC converter 101, boost circuit 102, and the main welding power control circuitry, which includes inverter 104, HF transformer 106, and secondary rectifier 108, which supplies welding power at the weld output to downstream welding equipment. However, HF transformer 106 has dual secondary windings, a first of which is coupled to secondary rectifier 108 that supplies the weld output, and the second of which is coupled to the battery power converter. For example, the primary and secondary winding ratios can be selected as follows: primary:secondary1:secondary2=400:90:90.

In the implementation shown in FIG. 5A, the battery power converter includes a bi-directional DC-DC converter 150 that couples battery 112 to an H-bridge circuit 152 which in turn is coupled to the second, secondary winding of HF transformer 106. By way of example, bi-directional DC-DC converter 150 can include a buck converter in a current flow direction from HF transformer 106 to battery 112 for charging battery 112, and a boost converter in a current flow direction from battery 112 to HF transformer 106 to discharge battery 112 during certain welding operation modes.

As shown in the simplified circuit diagram of FIG. 5B, H-bridge circuit 152 comprises four switching elements Q50, Q51, Q52, and Q53, such as transistors or IGBTs. Diodes D50, D51, D52, and D53 are respectively arranged in parallel with the four switching elements. Switching element Q50 is connected between a first end tap of the second secondary winding of HF transformer 106 and the positive terminal of bi-directional DC-DC converter 150, switching element Q51 is connected between a second end tap of the second secondary winding of HF transformer 106 and the positive terminal of bi-directional DC-DC converter 150, switching element Q52 is connected between the first end tap of the second secondary winding of HF transformer 106 and the ground terminal of battery 112, and switching element Q53 is connected between the second end tap of second secondary winding of HF transformer 106 and the ground terminal of battery 112. The gates of switching elements Q50-Q53 are controlled by the weld process controller such that H-bridge circuit 152 functions as a rectifier when current is flowing from the second secondary winding of HF transformer 106 to battery 112 to rectify the high-frequency AC power signal from HF transformer 106. When current is flowing from battery 112 to the second secondary winding of HF transformer 106, the weld process controller controls the gates of switching elements Q50-Q53 such that H-bridge circuit 152 functions as an inverter to convert the DC battery voltage to a high-frequency AC power signal that is supplied to the second secondary winding of HF transformer 106. Thus, in charging mode, H-bridge circuit 152 operates as a rectifier, and in discharging mode, H-bridge circuit 152 is switched at high frequency to operate as an inverter.

Still referring to FIG. 5B, bi-directional DC-DC converter 150 includes: an inductor L11 connected at one end to the positive terminal of battery 112 and at the other end to a first node; a boost switching element Q54 and a boost diode D54 arranged in parallel between the first node and the ground terminal of battery 112; a buck switching element Q55 and a buck diode D55 arranged in parallel between the first node and the positive terminal of bi-directional DC-DC converter 150 that is connected to H-bridge circuit 152; and a capacitor coupled between the ground terminal of battery 112 and the positive terminal of bi-directional DC-DC converter 150 that is connected to H-bridge circuit 152.

For discharging battery 112, boost switching element Q54 is switched on and off at a specified frequency such that boost switching element Q55, boost diode D54, inductor L11 and capacitor C11 operate as a DC-DC boost converter to up-convert (increase) the battery voltage level (e.g., 60 VDC) to a higher DC voltage to be supplied to H-bridge circuit 152, which converts the boosted DC voltage to a high-frequency AC voltage for delivery to the second secondary winding of HF transformer 106. For charging battery 112, buck switching element Q55 is switched on and off at a specified frequency such that buck switching element Q55, buck diode D55, inductor L11, and capacitor C11 operate as a DC-DC buck converter circuit to down-convert (decrease) the rectified voltage signal from H-bridge circuit 152 to a lower-voltage DC output signal at the positive terminal of battery 112 to enable charging of battery 112 from power flowing from HF transformer 106.

FIG. 5C illustrates the different modes of operation in the hybrid power welding system shown in FIGS. 5A and 5B. In welding mode (Mode 1), the AC input power is supplied to AC/DC converter 101 to produce the rectified input voltage, which is then boosted by boost circuit 102 to a higher DC link voltage (e.g., 400 V), which is supplied to the main welding power control circuitry. Specifically, inverter 104, HF transformer 106, and secondary rectifier 108 process the DC link voltage to deliver welding power to the weld output via the first, secondary winding of HF transformer 106. During this mode, switches in the battery power converter circuitry (e.g., switches in the boost and buck converters in bi-directional DC-DC converter 150) are in an “off” state such that battery 112 neither charges nor discharges.

In charging mode (Mode 2), the AC input power is supplied to AC/DC converter 101 to produce the rectified input voltage, which is then up-converted by boost converter 120 to a higher DC link voltage (e.g., 400 V). Inverter 106 is switched at high frequency to supply a high-frequency AC signal to the primary winding of HF transformer 106. Voltage from the second secondary winding of the transformer is rectified via H-bridge circuit 152 operating as a diode rectifier (D50-D53). The rectified voltage is further regulated to charge battery 112 via the buck converter of bi-directional DC-DC converter 150. In the bi-directional DC-DC converter, buck switching element Q55 is switched at specified switching frequency to regulate the battery charging voltage (e.g., 60V). In this mode, boost switching element Q54 of bi-directional DC-DC converter 150 is in an “off” state.

In hybrid welding/charging mode (Mode 3), the AC input power is supplied to AC/DC converter 101 to produce the rectified input voltage, which is then boosted by boost circuit 102 to a higher DC link voltage (e.g., 400 V). Inverter 106 is switched at high frequency to supply a high-frequency AC signal to the primary winding of HF transformer 106, and first, secondary winding of HF transformer 106 delivers power to secondary rectifier 108 to provide welding power to the weld output. Simultaneously, power from the second, secondary winding of the transformer is rectified by H-bridge circuit 152 operating as a diode rectifier (D50-D53). The rectified voltage is further regulated to charge battery 112 via the buck converter of bi-directional DC-DC converter 150, as previously described. In this mode, boost switching element Q54 of bi-directional DC-DC converter 150 is in an “off” state.

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency and delivers power to the primary winding of the transformer, which supplies power via its first secondary winding to secondary rectifier 108 to deliver welding power to the weld output. To supplement the power from the AC input with battery power, boost switching element Q54 of the bi-directional DC-DC converter is simultaneously switched at a specified switching frequency and boosts the battery voltage to a higher, regulated DC voltage level. The switching elements of H-bridge circuit 152 (Q50-Q55) are switched in synchronization with inverter 104 to supply battery power to the second, secondary winding of transformer 106 in the form of a high-frequency AC signal. The main and battery currents are thus summed. The synchronization of currents between the two converters are managed by the weld process controller.

The hybrid welding mode (Mode 5) is not feasible with the architecture shown in FIGS. 5A and 5B.

In battery welding mode (Mode 6), AC input power is not supplied to AC/DC converter 101. Inverter 104 is in an “off” state such that power does not flow through the main welding power control circuitry to the weld output. To delivery battery power to the weld output, boost switching element Q54 of bi-directional DC-DC converter 150 is switched at a specified frequency and boosts the battery voltage to a higher, regulated DC voltage level. The switching elements of H-bridge circuit 152 (Q50-Q55) are switched at high frequency to supply battery power to the second secondary winding of transformer 106 in the form of a high-frequency AC signal, which supplies power to secondary rectifier 108 to deliver welding power to the weld output.

A summary of the modes of operation for the first implementation of the direct transformer coupled architecture described in connection with FIGS. 5A-5C is provided in Table 5 below.

TABLE 5

| | |
|---|---|
| Modes of Operation | Description |
| 1. Welding Mode | AC input power routed through inverter to weld output |
| 2. Charging Mode | AC input power routed through transformer, H-bridge rectifier, and |
| | bi-directional DC-DC converter to charge the battery |
| 3. Hybrid Welding/Charging Mode | AC input power routed through inverter to weld output and routed |
| | through transformer and bi-directional DC-DC converter to charge |
| | the battery (Modes 1 & 2) |
| 4. Welding Boost Mode | AC input power routed through inverter to weld output and battery |
| | power routed through H-bridge inverter to transformer to weld |
| | output (modes 1 & 6) |
| 5. Hybrid Welding Mode | Not feasible |
| 6. Battery Welding Mode | Battery power routed through bi-directional DC-DC converter to H- |
| | bridge inverter and transformer to weld output |

B. Charge Via Buck Converter from DC Link/Discharge Through Boost Converter and H-Bridge to Transformer

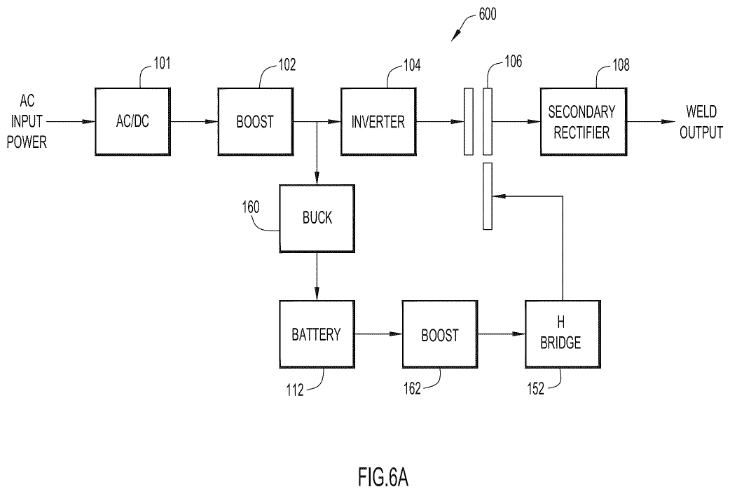

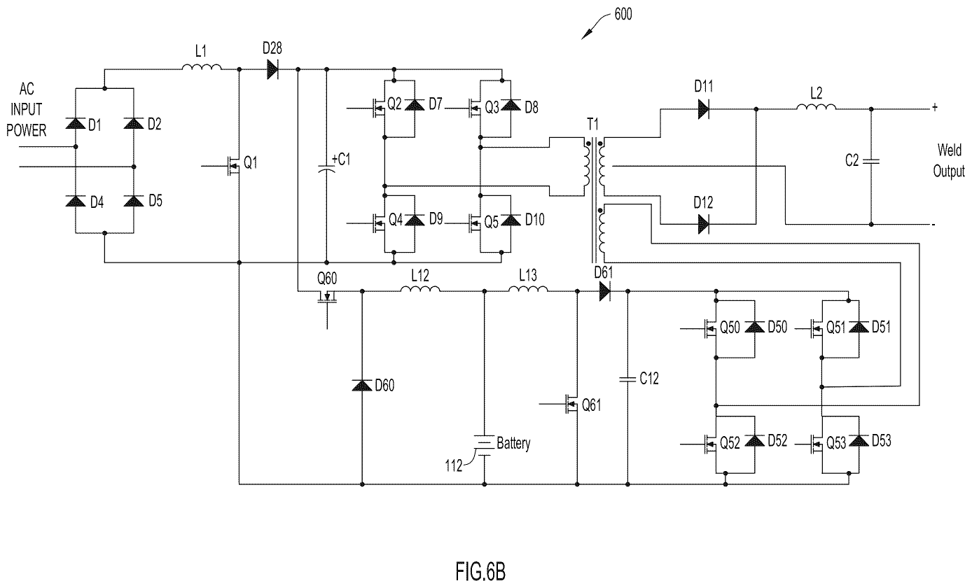

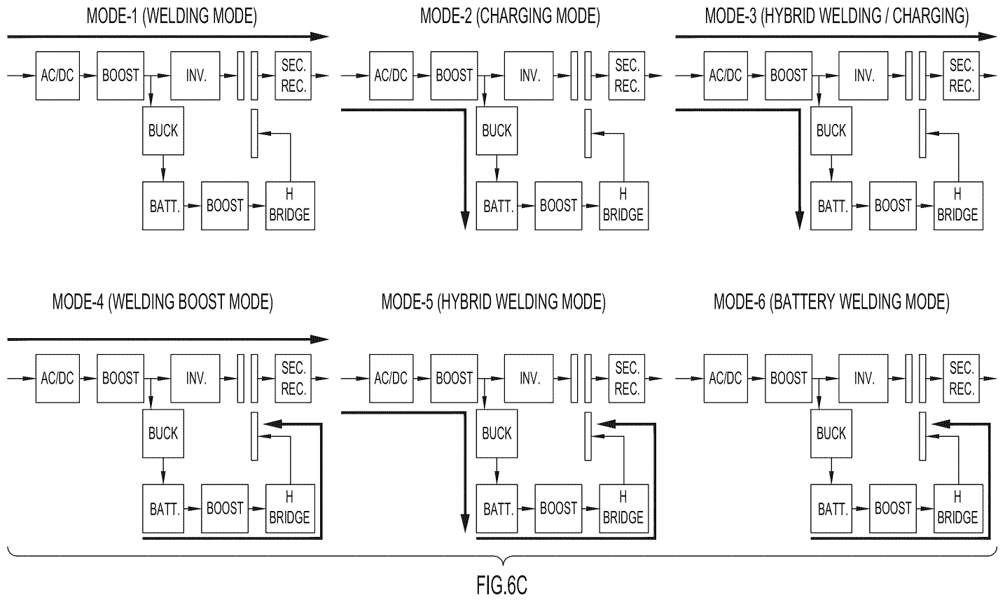

FIG. 6A is a block diagram of a second implementation of a hybrid power welding system 600 employing a high-frequency transformer coupled architecture in which a battery is coupled to the DC link upstream of the welding power control circuitry via a buck converter for charging and to a secondary winding of the HF transformer via a boost converter and H-bridge to supply welding power. FIG. 6B is a schematic representation of the hybrid power welding system 600 employing the high-frequency transformer coupled architecture shown in FIG. 6A.

The components of the main welding power source in FIG. 6A are similar to those in FIG. 1A, i.e., AC/DC converter 101, boost circuit 102, and the main welding power control circuitry, which includes inverter 104, HF transformer 106, and secondary rectifier 108, which supplies welding power at the weld output to downstream welding equipment. However, HF transformer 106 has dual secondary windings, a first of which is coupled to secondary rectifier 108 to supply power to the weld output, and the second of which is coupled to the battery power converter.

In the implementation shown in FIG. 6A, the battery power converter includes a buck converter 160 that couples battery 112 to the DC link upstream of the welding power control circuitry. Buck converter 160 receives power from the DC link at a higher voltage (e.g., 400 V) and down-converters (decreases) the voltage to a lower level (e.g., 60 V) suitable for charging battery 112. The battery power converter further includes a DC-DC boost converter 162 and an H-bridge 152 for coupling battery 112 to the second, secondary winding of the HF transformer in order to discharge battery 112 to supply power to the weld output.

As shown in the simplified circuit diagram of FIG. 6B, H-bridge circuit 152 has the same architecture as that shown in FIG. 5B. However, because H-bridge 152 is used in this case for discharging battery 112 to the second secondary winding of transformer 106 and not for charging battery 112, H-bridge is not operated as a rectifier. When current is flowing from battery 112 to the second secondary winding of HF transformer 106, the weld process controller controls the gates of switching elements Q50-Q53 such that H-bridge circuit 152 functions as an inverter to convert the DC battery voltage to a high-frequency AC power signal that is supplied to the second secondary winding of HF transformer 106.

Still referring to FIG. 6B, buck converter 160 includes: a switching element Q60 (e.g., a transistor or IGBT) connected at one end to the positive line of the DC link downstream of diode D28 and connected at the other end to a first node; a diode D60 connected between the first node and the ground terminal of battery 112; and an inductor L12 connected between the first node and the positive terminal of battery 112. For charging battery 112, switching element Q60 is switched on and off at a specified frequency such that switching element Q60, diode D60, and inductor L12 operate as a DC-DC buck circuit to down-convert (decrease) the DC link voltage to a lower-voltage DC output signal at the positive terminal of battery 112 to enable charging of battery 112 from the DC link.

Boost converter 162 includes: an inductor L13 connected at one end to the positive terminal of battery 112 and at the other end to a second node; a boost switching element Q61 connected between the second node and the ground terminal of battery 112; a diode D61 connected between the second node and the positive input terminal of H-bridge 152; and a capacitor C12 connected between the positive and negative input terminals of H-bridge 152 downstream of diode D61. For discharging battery 112, switching element Q61 is switched on and off at a specified frequency such that switching element Q61, diode D61, inductor L13, and capacitor C12 operate as a DC-DC boost converter to up-convert (increase) the battery voltage level (e.g., 60 VDC) to a higher DC voltage to be supplied to H-bridge circuit 152, which converts the boosted DC voltage to a high-frequency AC voltage for delivery to the second secondary winding of HF transformer 106.

FIG. 6C illustrates the different modes of operation in the hybrid power welding system shown in FIGS. 6A and 6B. In welding mode (Mode 1), the AC input power is supplied to AC/DC converter 101 to produce the rectified input voltage, which is then boosted by boost circuit 102 to a higher DC link voltage (e.g., 400 V), which is supplied to the welding power control circuitry. Specifically, inverter 104, HF transformer 106, and secondary rectifier 108 process the DC link voltage to deliver welding power to the weld output. During this mode, switches in the battery power converter circuitry (e.g., switches in buck converter 160, boost converter 162, and H-bridge 152) are in an “off” state such that battery 112 neither charges nor discharges.

In charging mode (Mode 2), the AC input power is supplied to AC/DC converter 101 to produce the rectified input voltage, which is then boosted by boost circuit 102 to a higher DC link voltage (e.g., 400 V). Inverter 104 and H-Bridge 152 are in an “off” state, such that neither the AC input power nor battery power is supplied to the weld output. In buck converter 160, switching element Q60 is switched at a specified frequency to regulate and down-convert the DC link voltage to a suitable battery charging voltage (e.g., 60V).

In hybrid welding/charging mode (Mode 3), the AC input power is supplied to AC/DC converter 101 to produce the rectified input voltage, which is then boosted by boost circuit 102 to a higher DC link voltage (e.g., 400 V). Inverter 106 is switched at high frequency to supply a high-frequency AC signal to the primary winding of HF transformer 106, and first, secondary winding of HF transformer 106 delivers power to secondary rectifier 108 to provide welding power to the weld output. Simultaneously, H-bridge 152 and/or boost converter 162 are maintained in an “off” state such that battery power is not discharged or supplied to the weld output. In buck converter 160, switching element Q60 is switched at a specified frequency to regulate and down-convert the DC link voltage to a suitable battery charging voltage (e.g., 60V).

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency and delivers power to the primary winding of the transformer, which supplies power via its first secondary winding to secondary rectifier 108 to deliver welding power to the weld output. To supplement the power from the AC input with battery power, switching element Q61 of the boost converter 162 is simultaneously switched at a specified frequency and up-converts the battery voltage to a higher, regulated DC voltage level. The switching elements of H-bridge circuit 152 (Q50-Q55) are switched in synchronization with inverter 104 to supply battery power to the second, secondary winding of the transformer in the form of a high-frequency AC signal. The main and battery currents are thus summed. The synchronization of currents between the two converters are managed by the weld process controller. Specifically, the power outputs from both the first and second secondary windings of HF transformer 106 are rectified by a center tapped rectifier bridge (D11-D12) of secondary rectifier 108 and delivered to the boosted weld output. During this mode, buck converter 160 is maintained in an “off” state to prevent charging of battery 112 from the DC link.

In hybrid welding mode (Mode 5), the AC input power is supplied to AC/DC converter 101 to produce the rectified input voltage, which is then boosted by boost circuit 102 to a higher DC link voltage (e.g., 400 V). Inverter 104 is in an “off” state, such that the AC input power is not supplied to the weld output. In buck converter 160, switching element Q60 is switched at a specified switching frequency to regulate and down-convert the DC link voltage to the battery charging voltage (e.g., 60V). Simultaneously, in boost converter 162, switching element Q61 is switched at a specified frequency and up-converts the battery voltage to a higher, regulated DC voltage level. The switching elements of H-bridge circuit 152 (Q50-Q55) are switched at high frequency to supply battery power to the second secondary winding of transformer 106 in the form of a high-frequency AC signal. The power output from the second secondary winding of transform 106 is rectified by a center tapped rectifier bridge (D11-D12) of secondary rectifier 108 and delivered to the weld output.

In battery welding mode (Mode 6), AC input power is not supplied to AC/DC converter 101. Inverter 104 is in an “off” state such that power does not flow through the main welding power control circuitry to the weld output. To delivery battery power to the weld output, switching element Q61 of boost converter 162 is switched at a specified frequency and up-converts the battery voltage to a higher, regulated DC voltage level. The switching elements of H-bridge circuit 152 (Q50-Q55) are switched at high frequency to supply battery power to the second secondary winding of transformer 106 in the form of a high-frequency AC signal. The power output from the second secondary winding of HF transformer 106 are rectified by a center tapped rectifier bridge (D11-D12) of secondary rectifier 108 and delivered to the weld output.

A summary of the modes of operation for the second implementation of the direct transformer coupled architecture described in connection with FIGS. 6A-6C is provided in Table 6 below.

TABLE 6

| Modes of Operation | Description |
|---|---|
| 1. Welding Mode | AC input power routed through inverter to weld output |
| 2. Charging Mode | AC input power routed through DC link and buck converter to |
| | charge the battery |
| 3. Hybrid Welding/Charging Mode | AC input power routed through inverter to weld output and routed |
| | through buck converter to charge the battery (Modes 1 & 2) |
| 4. Welding Boost Mode | AC input power routed through inverter to weld output and battery |
| | power routed through boost converter, H-bridge, and transformer |
| | to weld output (modes 1 & 6) |
| 5. Hybrid Welding Mode | AC input power routed through buck converter to charge the |
| | battery and battery power routed through boost converter, H- |
| | bridge, and transformer to weld output (modes 2 & 6) |
| 6. Battery Welding Mode | Battery power routed through boost converter, H-bridge, and |
| | transformer to weld output |

C. Charge Via Buck Converter from AC Input/Discharge Through Boost Converter and H-Bridge to Transformer

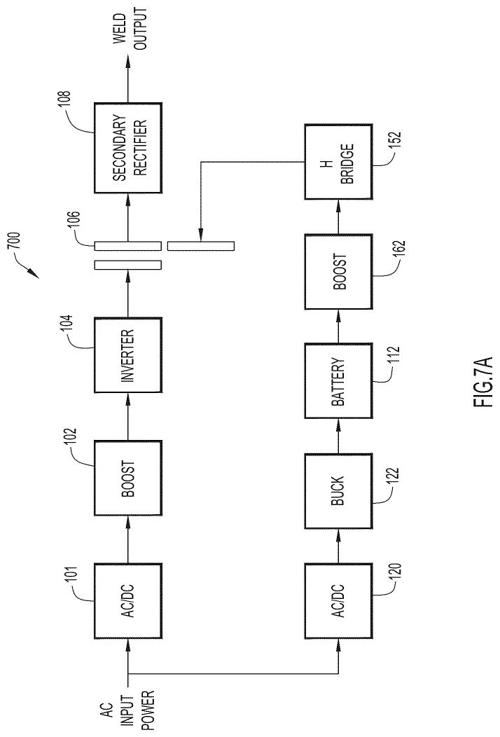

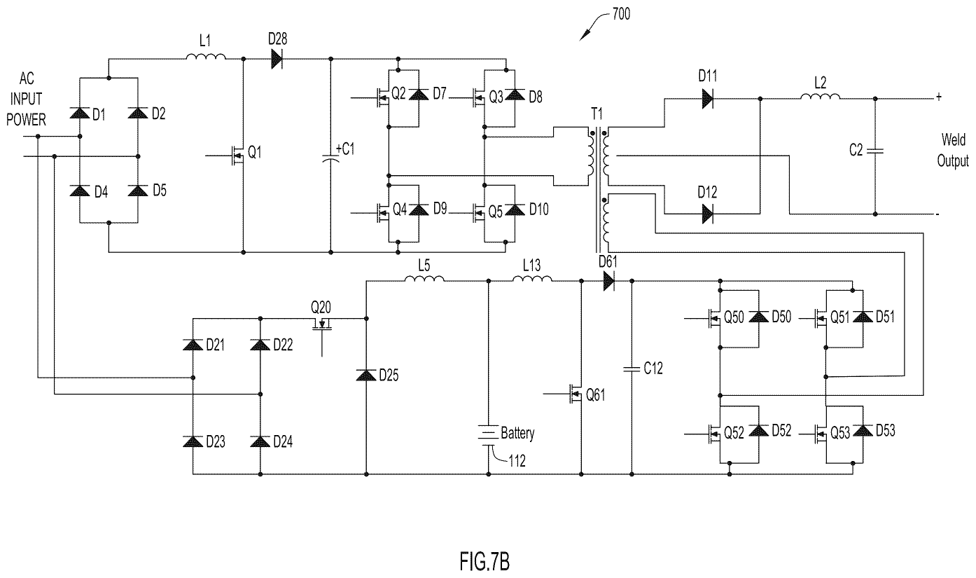

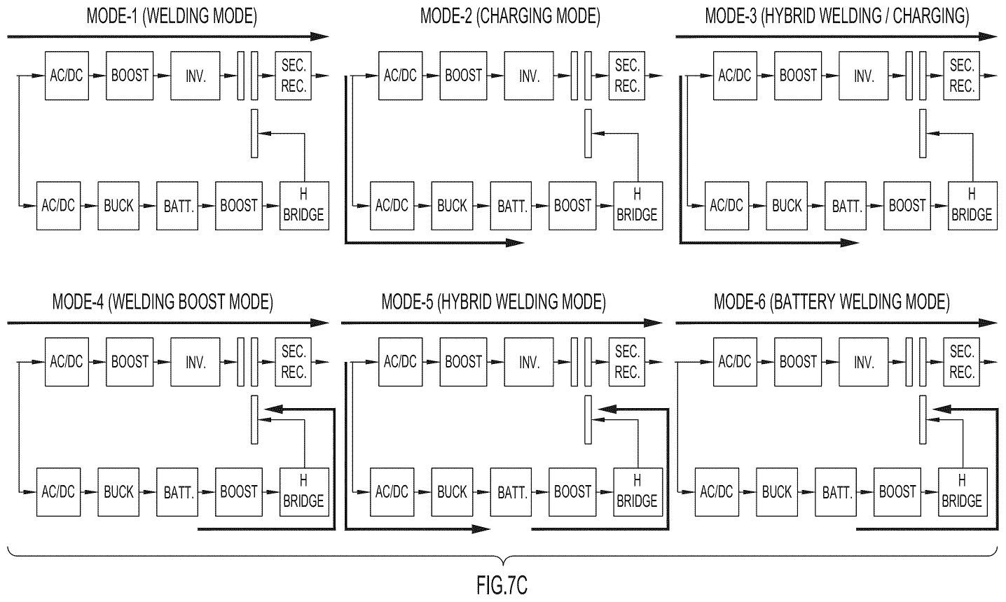

FIG. 7A is a block diagram of a third implementation of a hybrid power welding system 700 employing a high-frequency transformer coupled architecture in which a battery is linked to the AC input via an AC/DC converter and a buck converter for charging and to a secondary winding of the transformer via a boost converter and an H-bridge to supply welding power. FIG. 7B is a schematic representation of the hybrid power welding system 700 employing the high-frequency transformer coupled architecture shown in FIG. 7A.

The components of the main welding power source in FIG. 7A are the same as those in FIG. 6A, i.e., AC/DC converter 101, boost converter 102, and the main welding power control circuitry, which includes inverter 104, HF transformer 106, and secondary rectifier 108, which supplies welding power at the weld output to downstream welding equipment. HF transformer 106 has dual secondary windings, a first of which is coupled to the secondary rectifier 108 to supply power to the weld output, and the second of which is coupled to the battery power converter.

In the implementation shown in FIG. 7A, the battery power converter includes second AC/DC converter 120 coupled to the AC input to receive at least a portion of the AC input power when on, and DC-DC buck converter 122 that receives rectified power from AC/DC converter 120 and down-converters (decreases) the voltage to a lower level (e.g., 60 V) suitable for charging battery 112. Note that second AC/DC converter 120 and buck converter 122 can be implemented in the manner described in connection with FIGS. 2A and 2B. The battery power converter further includes DC-DC boost converter 162 and H-bridge 152 for coupling battery 112 to the second, secondary winding of HF transformer 106 in order to discharge battery 112 to supply power to the weld output. Note that boost converter 162 and H-bridge 152 can be implemented in the manner previously described in connection with FIGS. 6A and 6B.

FIG. 7C illustrates the different modes of operation in the hybrid power welding system shown in FIGS. 7A and 7B. In welding mode (Mode 1), the AC input power is supplied to AC/DC converter 101 to produce the rectified input voltage, which is then boosted by boost circuit 102 to a higher DC link voltage (e.g., 400 V), which is supplied to the welding power control circuitry. Specifically, inverter 104, HF transformer 106, and secondary rectifier 108 process the DC link voltage to deliver welding power to the weld output. During this mode, switches in the battery power converter circuitry (e.g., switches in buck converter 122, boost converter 162, and H-bridge 152) are in an “off” state such that battery 112 neither charges nor discharges.

In charging mode (Mode 2), the AC input power is supplied to second AC/DC converter 120 to produce a second rectified DC voltage. In buck converter 122, switching element Q20 is switched at a specified switching frequency to down-convert the second rectified DC voltage to a suitable battery charging voltage (e.g., 60V) to regulate charging of battery 112. The path through the main welding power source circuitry is switched to an “off” state in this mode (e.g., via switching elements in boost circuit 102 and inverter 104) such that the AC input power does not pass through the main welding power source circuitry. Likewise, boost converter 162 and H-bridge 152 can be switched off, such that neither the input power nor battery power is supplied to the weld output.

In hybrid welding/charging mode (Mode 3), a portion of the AC input power is supplied to AC/DC converter 101 to produce the rectified input voltage, which is then boosted by boost circuit 102 to a higher DC link voltage (e.g., 400 V). Inverter 104 is switched at high frequency to supply high-frequency AC power to HF transformer 106, and secondary rectifier 108 delivers the welding power to the weld output. Simultaneously, the remaining portion of the AC input power is supplied to second AC/DC converter 120 to produce a second rectified DC voltage. In buck converter 122, switching element Q20 is switched at a specified switching frequency to down-convert the second rectified DC voltage to a suitable battery charging voltage (e.g., 60V) to regulate charging of battery 112. Boost converter 162 and H-bridge 152 are switched off to prevent battery power from discharging to the DC link.

In welding boost mode (Mode 4), the AC input power is supplied to AC/DC converter 101 to produce the rectified input voltage, which is then boosted by boost circuit 102 to a higher DC link voltage (e.g., 400 V). Inverter 104 is switched at high frequency and delivers power to the primary winding of the transformer, which supplies power via its first secondary winding to secondary rectifier 108 to deliver welding power to the weld output. To supplement the power from the AC input with battery power, switching element Q61 of the boost converter 162 is simultaneously switched at a specified frequency and up-converts the battery voltage to a higher, regulated DC voltage level. The switching elements of H-Bridge circuit 152 (Q50-Q55) are switched in synchronization with inverter 104 to supply battery power to the second, secondary winding of the transformer in the form of a high-frequency AC signal. The main and battery currents are thus summed. The synchronization of currents between the two converters are managed by the weld process controller. Specifically, the power outputs from both the first and second secondary windings of HF transformer 106 are rectified by a center tapped rectifier bridge (D11-D12) of secondary rectifier 108 and delivered to the boosted weld output. During this mode, buck converter 122 is maintained in an “off” state to prevent charging of battery 112 from the DC link.

In hybrid welding mode (Mode 5), boost circuit 102 is in an “off” state such that AC input power does not reach the DC link via the main welding power control circuitry path. The AC input power is supplied to second AC/DC converter 120 of the battery power converter to produce a second rectified DC voltage. In buck converter 122, switching element Q20 is switched at a specified switching frequency to down-convert the second rectified DC voltage to a suitable battery charging voltage (e.g., 60V) to regulate charging of battery 112. Simultaneously, in boost converter 162, switching element Q61 is switched at a specified frequency and up-converts the battery voltage to a higher, regulated DC voltage level. The switching elements of H-Bridge circuit 152 (Q50-Q55) are switched at high frequency to supply battery power to the second secondary winding of transformer 106 in the form of a high-frequency AC signal. The power output from the second secondary winding of transform 106 is rectified by a center tapped rectifier bridge (D11-D12) of secondary rectifier 108 and delivered to the weld output.

In battery welding mode (Mode 6), AC input power is not supplied to AC/DC converter 101 or second AC/DC converter 120. Inverter 104 is in an “off” state such that power does not flow through the main welding power control circuitry to the weld output. To delivery battery power to the weld output, switching element Q61 of boost converter 162 is switched at a specified frequency and up-converts the battery voltage to a higher, regulated DC voltage level. The switching elements of H-Bridge circuit 152 (Q50-Q55) are switched at high frequency to supply battery power to the second secondary winding of transformer 106 in the form of a high-frequency AC signal. The power output from the second secondary winding of HF transformer 106 are rectified by a center tapped rectifier bridge (D11-D12) of secondary rectifier 108 and delivered to the weld output.

A summary of the modes of operation for the third implementation of the direct transformer coupled architecture described in connection with FIGS. 7A-7C is provided in Table 7 below.

TABLE 7

| Modes of Operation | Description |
|---|---|
| 1. Welding Mode | AC input power routed through inverter to weld output |
| 2. Charging Mode | AC input power routed through second AC/DC converter and buck |
| | converter to charge the battery |
| 3. Hybrid Welding/Charging Mode | AC input power routed through inverter to weld output and routed |
| | through second AC/DC converter and buck converter to charge the |
| | battery (Modes 1 & 2) |
| 4. Welding Boost Mode | AC input power routed through inverter to weld output and battery |
| | power routed through boost converter, H-bridge, and transformer |
| | to weld output (modes 1 & 6) |
| 5. Hybrid Welding Mode | AC input power routed through second AC/DC converter and buck |
| | converter to charge the battery and battery power routed through |
| | boost converter, H-bridge, and transformer to weld output (modes |
| | 2 & 6) |
| 6. Battery Welding Mode | Battery power routed through boost converter, H-bridge, and |
| | transformer to weld output |

4. HF Transformer Coupling Architecture with Brake Resistor Battery Charging

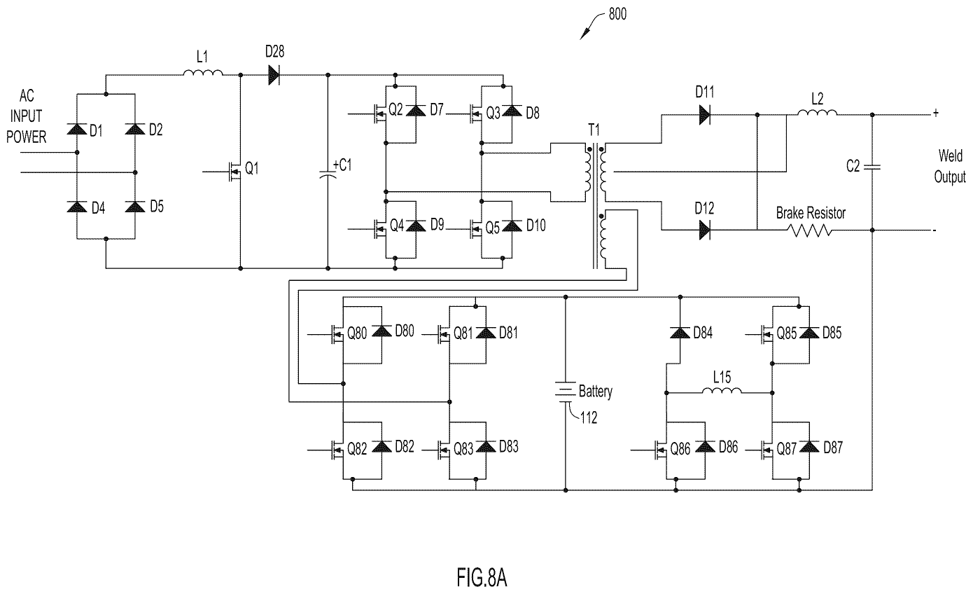

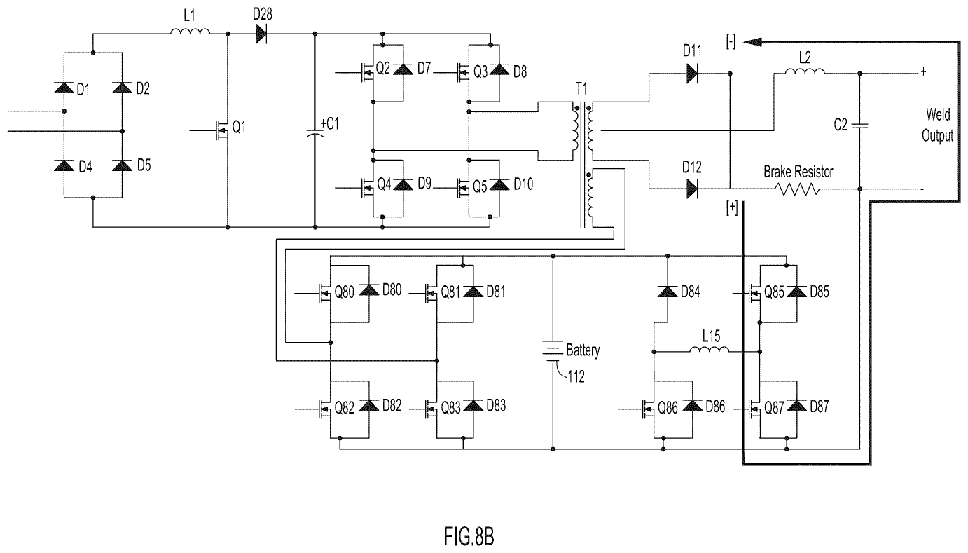

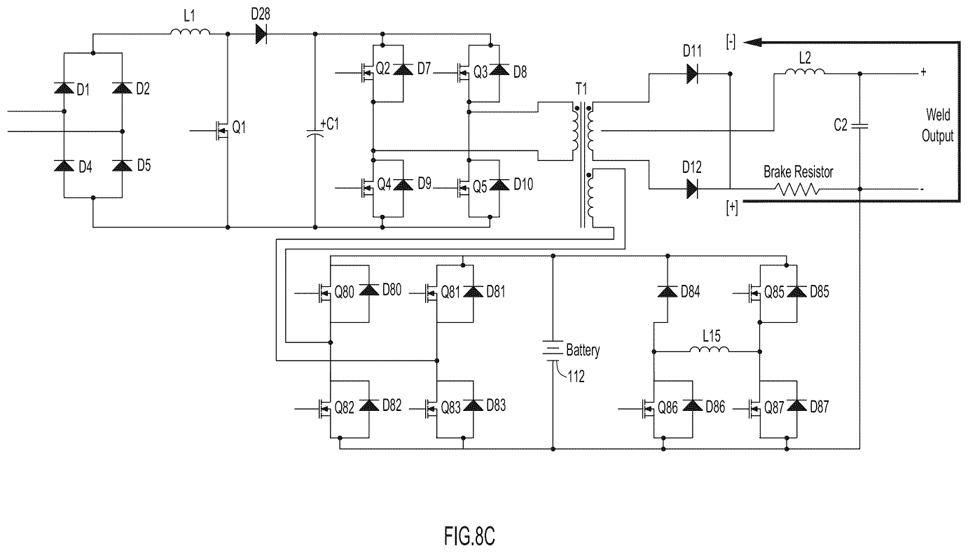

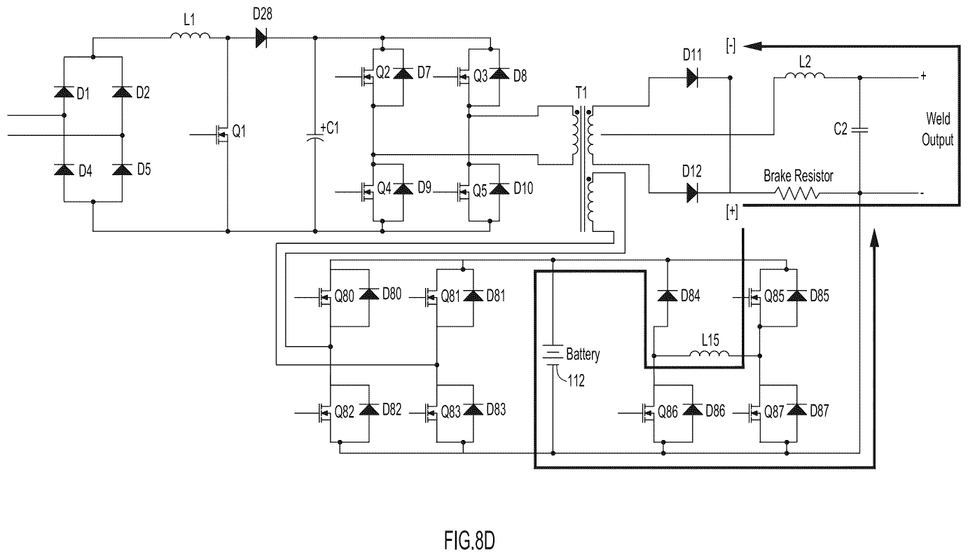

FIG. 8A is a schematic representation of an implementation of a hybrid power welding system 800 employing a high-frequency transformer coupling architecture with battery charging via a brake resistor. The components of the main welding power source in FIG. 8A are similar to those in FIGS. 6B, 7B, and 8B, i.e., AC/DC converter 101, boost converter 102, and the main welding power control circuitry, which includes inverter 104, HF transformer 106, and secondary rectifier 108, which supplies welding power at the weld output to downstream welding equipment. HF transformer 106 includes a primary winding and first and second secondary windings.

In the implementation shown in FIG. 8A, the battery power converter includes an H-bridge coupling battery 112 to the second, secondary winding of HF transformer 106. The H-bridge comprises four switching elements Q80, Q81, Q82, and Q83, such as transistors or IGBTs. Diodes D80, D81, D82, and D83 are respectively arranged in parallel with the four switching elements. Switching element Q80 is connected between a first end tap of the second secondary winding of HF transformer 106 and the positive terminal of battery 112, switching element Q81 is connected between a second end tap of the second secondary winding of HF transformer 106 and the positive terminal of battery 112, switching element Q82 is connected between the first end tap of the second secondary winding of HF transformer 106 and the ground terminal of battery 112, and switching element Q83 is connected between the second end tap of second secondary winding of HF transformer 106 and the ground terminal of battery 112.

Battery 112 is also coupled to the weld output via a bi-directional DC-DC converter circuit that performs boost conversion of power output (discharged) from battery 112 to the weld output and boost conversion of power supplied to battery 112 (charging) from a brake resistor at the weld output and from the second, secondary winding of HF transformer 106 according to certain welding operation modes. The bi-directional DC-DC converter includes: a diode D84 connected at one end to the positive terminal of battery 112 and at the other end to a first node; a switching element Q86 connected at one end to the first node and connected at the other end to ground; a diode D86 connected in parallel with switching element Q86; a switching element Q85 connected in parallel with a diode D85 between the positive terminal of battery 112 and a second node; a switching element Q87 connected in parallel with diode D87 between the second node and ground; and an inductor L15 connected between the first and second nodes.

As shown in FIG. 8A, a brake resistor is connected at one end to the downstream end of D12 of secondary rectifier 108 and is connected at the other end to the negative terminal of the weld output.

In consumable electrode arc welding, one of the recognized modes of operation is the short-circuiting mode, wherein a power supply is connected across the consumable electrode, or welding wire, and the workpiece onto which a weld bead is to be deposited. As an arc is created, the end of the electrode melts to form a globular mass of molten metal hanging on the electrode and extending toward the workpiece. When this mass of molten material becomes large enough, it bridges the gap between the electrode and the workpiece to cause a short circuit. At that time, the voltage between the electrode and the workpiece drops drastically thereby causing the power supply to drastically increase the current through the short circuit. Such high current flow is sustained and is actually increased with time through the molten mass as the power supply inductance is overcome. Since this short circuit current continues to flow, an electric pinch necks down a portion of the molten mass adjacent the end of the welding wire. The force causing the molten welding wire to neck down is proportional to the square of the current flowing through the molten metal at the end of the welding wire. Controlled short arc welding is an example of a welding technique that employs a cyclical droplet transfer in which a molten droplet briefly forms a short circuit between electrode and workpiece before separating from the electrode and reestablishing an arc between the electrode and workpiece.

A brake switch can be used during short circuit periods to dissipate energy via a break resistor to avoid spatter caused by excess energy during short circuit welding transfer modes. A switch can be operated in response to the sensed arc voltage and the current level to switch the brake resistor into and out of the output power path to rapidly attenuate circulating current levels during short circuit periods. According to the implementation in FIG. 8A, instead of dissipating all of the excess energy as heat via the brake resistor, at least some of the energy is used to charge battery 112 in certain modes (e.g., Mode 1—welding mode and Mode 3—Hybrid welding/charging mode). This mechanism has the further advantage of reducing the requirements of the brake resistor.

As shown in FIG. 8B, during normal welding mode, switching elements Q85 and Q87 are turned on, which bypasses the brake resistor, making a direct connection to the weld output. During short circuit weld transfer mode or other short-circuit periods, switching elements Q85 and Q87 are initially turned off such that the brake resistor is connected in the weld output circuit, as shown in FIG. 8C. This causes the excess voltage to appear across the brake resistor, i.e., a brake resistor potential. Once the excess voltage appears in the brake resistor, switching element Q85 is kept on. Switching element Q86 is switched at a specified switching frequency. This operation forms a boost converter with the help of inductor L15 and diode D86, such that the resulting regulated voltage charges battery 112, as shown in FIG. 8D. In the implementation of FIG. 8A, charging of battery 112 via the brake resistor is not possible while battery 112 is delivering power to the weld output.

Although the disclosure illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the implementations may be incorporated into another of the implementations. Accordingly, it is appropriate that the appended claims be construed broadly and in a manner consistent with the scope of the disclosure.

What is claimed is:

1. A hybrid welding power system, comprising:
an AC/DC converter to generate a rectified voltage from AC input power;
a boost circuit to generate a DC link voltage from the rectified voltage;
an inverter to generate a transformer input from the DC link voltage in accordance with a welding operation;
a high-frequency (HF) transformer to receive the transformer input and generate a transformer output having current and voltage characteristics suitable for the welding operation;
a secondary rectifier to rectify the transformer output to generate output welding power to be supplied to a weld output of the welding power system; and
a battery power converter to couple a battery to the weld output to enable discharging of the battery to the weld output.

2. The hybrid welding power system of claim 1, wherein the battery power converter comprises:
a second inverter to receive DC battery power and generate a second transformer input in accordance with the welding operation;
a second HF transformer to receive the second transformer input and generate a second transformer output having current and voltage characteristics suitable for a welding operation; and
a second secondary rectifier to rectify the second transformer output to generate output welding power to be supplied to the weld output.

3. The hybrid welding power system of claim 1, wherein the battery power converter comprises:
a DC-DC buck converter to down-convert the DC link voltage to a battery charging voltage that is supplied to the battery for charging.

4. The hybrid welding power system of claim 1, wherein the battery power converter comprises:
a four quadrant converter to couple the battery to the weld output, wherein:
in a charging mode, current flows from the weld output to the battery and the four quadrant converter operates as a DC-DC buck converter; and
in a discharging mode, current flows from the battery to the weld output and the four quadrant converter operates as a DC-DC boost converter.

5. The hybrid welding power system of claim 1, wherein the hybrid welding power system is operable in a welding boost mode in which the output welding power includes power derived from the AC input power combined with power from the battery.

6. The hybrid welding power system of claim 1, wherein the hybrid welding power system is operable in a hybrid welding/charging mode in which the battery is charged and the output welding power is supplied to the weld output for the welding operation simultaneously.

7. A hybrid welding power system, comprising:
an AC/DC converter to generate a rectified voltage from AC input power;
a boost circuit to generate a DC link voltage from the rectified voltage;
an inverter to generate a transformer input from the DC link voltage in accordance with a welding operation;
a high-frequency (HF) transformer to receive the transformer input and generate a transformer output having current and voltage characteristics suitable for the welding operation;
a secondary rectifier to rectify the transformer output to generate output welding power to be supplied to a weld output of the welding power system; and
a battery power converter to couple a battery to the hybrid welding power system at a DC link upstream of the inverter to enable discharging of the battery to the DC link.

8. The hybrid welding power system of claim 7, wherein the battery power converter comprises:
a DC-DC boost converter to couple the battery to the DC link to up-convert DC battery power to the DC link voltage.

9. The hybrid welding power system of claim 7, wherein the battery power converter comprises:
a second AC/DC converter to generate a second rectified voltage from an output of a secondary winding of the HF transformer; and
a DC-DC buck converter to down-convert the second rectified voltage to a battery charging voltage that is supplied to the battery for charging.

10. The hybrid welding power system of claim 7, wherein the hybrid welding power system is operable in a welding boost mode in which the output welding power includes power derived from the AC input power combined with power from the battery.

11. The hybrid welding power system of claim 7, wherein the hybrid welding power system is operable in a hybrid welding/charging mode in which the battery is charged and the output welding power is supplied to the weld output simultaneously.

12. A hybrid welding power system, comprising:
an AC/DC converter to generate a rectified voltage from AC input power;
a boost circuit to generate a DC link voltage from the rectified voltage;
an inverter to generate a transformer input from the DC link voltage in accordance with a welding operation;
a high-frequency (HF) transformer to receive the transformer input and generate a transformer output having current and voltage characteristics suitable for the welding operation;
a secondary rectifier to rectify the transformer output to generate output welding power to be supplied to a weld output of the welding power system; and
a battery power converter to couple a battery to a secondary winding of the HF transformer to enable discharging of the battery to the HF transformer.

13. The hybrid welding power system of claim 12, wherein the battery power converter comprises:
a DC-DC boost converter to up-convert DC battery power to a higher voltage; and
a second inverter to convert the up-converted DC battery power to high-frequency AC power that is supplied to the secondary winding of the HF transformer.

14. The hybrid welding power system of claim 12, wherein the battery power converter comprises:
a bi-directional DC-DC converter coupled to the battery; and
an H-bridge circuit coupled to the bi-directional DC-DC converter and to the secondary winding of the HF transformer, wherein:
in a charging mode, current flows from the secondary winding of the HF transformer to the battery, the H-bridge operates as a rectifier, and the bi-directional DC-DC converter operates as a DC-DC buck converter; and
in a discharging mode, current flows from the battery to the secondary winding of the HF transformer, and the bi-directional DC-DC converter operates as a DC-DC boost converter.

15. The hybrid welding power system of claim 12, wherein the battery power converter comprises:
a DC-DC buck converter to down-convert the DC link voltage to a battery charging voltage that is supplied to the battery for charging.

16. The hybrid welding power system of claim 12, wherein the battery power converter comprises:
a second AC/DC converter to generate a second rectified voltage from the AC input power; and
a DC-DC buck converter to down-convert the second rectified voltage to a battery charging voltage that is supplied to the battery for charging.

17. The hybrid welding power system of claim 12, wherein the hybrid welding power system is operable in a welding boost mode in which the output welding power includes power derived from the AC input power combined with power from the battery.

18. A hybrid welding power system, comprising:
an AC/DC converter to generate a rectified voltage from AC input power;
a boost circuit to generate a DC link voltage from the rectified voltage;
an inverter to generate a transformer input from the DC link voltage in accordance with a welding operation;
a high-frequency (HF) transformer to receive the transformer input and generate a transformer output having current and voltage characteristics suitable for the welding operation;
a secondary rectifier to rectify the transformer output to generate output welding power to be supplied to a weld output of the welding power system;
a brake resistor coupled between the secondary rectifier and the weld output to develop a brake resistor potential during short-circuit periods of the welding operation; and
a battery power converter to couple the brake resistor to a battery to enable charging of the battery during short-circuit periods of the welding operation.

19. The hybrid welding power system of claim 18, wherein the battery power converter comprises an H-bridge circuit to couple the battery to a secondary winding of the HF transformer.

20. The hybrid welding power system of claim 18, wherein the battery power converter comprises a bi-directional DC-DC converter circuit to couple the battery to the weld output and to the brake resistor.
